(19) United States
(12) Patent Application Publication
(10) Pub. No.: US 2026/0238812 A1
(43) Pub. Date: Aug. 13, 2026

(54) MESH DATA TRANSMISSION DEVICE, MESH DATA TRANSMISSION METHOD, MESH DATA RECEPTION DEVICE, AND MESH DATA RECEPTION METHOD

(71) Applicant: LG Electronics Inc., Seoul (KR)

(72) Inventors: Yeojin YOON, Seoul (KR); Joohyung BYEON, Seoul (KR); Donggyu SIM, Seoul (KR)

(21) Appl. No.: 19/160,620

(22) PCT Filed: Mar. 13, 2024
(86) PCT No.: PCT/KR2024/003232

§ 371 Date: Aug. 28, 2025

(30) Foreign Application Priority Data
Mar. 14, 2023 (KR) 10-2023-0033549

(51) Int. Cl. H04N 19/54; H04N 19/124; H04N 19/184; H04N 19/52

(52) U.S. Cl. CPC H04N 19/54; H04N 19/124; H04N 19/184; H04N 19/52

(57) ABSTRACT

A mesh data transmission method according to embodiments may comprise the steps of: encoding mesh data; and transmitting a bitstream including the mesh data. A mesh data reception method according to embodiments may comprise the steps of: receiving a bitstream including mesh data; and decoding the mesh data.

### TECHNICAL FIELD

Embodiments provide a method for providing point cloud content to provide a user with various services such as virtual reality (VR), augmented reality (AR), mixed reality (MR), and self-driving services.

### BACKGROUND ART

A point cloud is a set of points in a three-dimensional (3D) space. It is difficult to generate point cloud data because the number of points in the 3D space is large.

A large throughput is required to transmit and receive data of a point cloud.

### DISCLOSURE

### Technical Problem

An object of the present disclosure devised to solve the above-described problems is to provide a point cloud data transmission device, a point cloud data transmission method, a point cloud data reception device, and a point cloud data reception method for efficiently transmitting and receiving a point cloud.

Another object of the present disclosure is to provide a point cloud data transmission device, a point cloud data transmission method, a point cloud data reception device, and a point cloud data reception method for addressing latency and encoding/decoding complexity.

Embodiments are not limited to the above-described objects, and the scope of the embodiments may be extended to other objects that can be inferred by those skilled in the art based on the entire contents of the present disclosure.

### Technical Solution

To achieve these objects and other advantages, a method of transmitting mesh data according to embodiments may include encoding mesh data, and transmitting a bitstream containing the mesh data. A method of receiving mesh data according to embodiments may include receiving a bitstream containing mesh data, and decoding the mesh data.

### Advantageous Effects

The point cloud data transmission method, the point cloud data transmission device, the point cloud data reception method, and the reception device according to embodiments may provide a quality point cloud service.

The point cloud data transmission method, point cloud data transmission device, point cloud data reception method, and point cloud data reception device according to embodiments may achieve various video codec methods.

The point cloud data transmission method, point cloud data transmission device, point cloud data reception method, and point cloud data reception device according to embodiments may provide universal point cloud content such as an autonomous driving service.

### DESCRIPTION OF DRAWINGS

The accompanying drawings, which are included to provide a further understanding of the disclosure and are incorporated in and constitute a part of this application, illustrate embodiment(s) of the disclosure and together with the description serve to explain the principle of the disclosure. For a better understanding of various embodiments described below, reference should be made to the description of the following embodiments in connection with the accompanying drawings. The same reference numbers will be used throughout the drawings to refer to the same or like parts. In the drawings:

FIG. 1 illustrates a system for providing dynamic mesh content according to embodiments;

FIG. 2 illustrates a V-MESH compression method according to embodiments;

FIG. 3 illustrates pre-processing in V-MESH compression according to embodiments;

FIG. 4 illustrates a mid-edge subdivision method according to embodiments;

FIG. 5 illustrates a displacement generation process according to embodiments;

FIG. 6 illustrates an intra-frame encoding process in a V-MESH compression method according to embodiments;

FIG. 7 illustrates an inter-frame encoding process for V-MESH data according to embodiments;

FIG. 8 illustrates a lifting transform process for displacements according to embodiments;

FIG. 9 illustrates a process of packing transform coefficients into a 2D image according to embodiments;

FIG. 10 illustrates an attribute transfer process in a V-MESH compression method according to embodiments;

FIG. 11 illustrates an intra-frame decoding process in a V-MESH compression method according to embodiments;

FIG. 12 illustrates V-MESH compression inter frame decoding process according to embodiments;

FIG. 13 illustrates a point cloud data transmission device according to embodiments;

FIG. 14 illustrates a point cloud data reception device according to embodiments;

FIG. 15 illustrates a dynamic mesh encoder according to embodiments;

FIG. 16 illustrates a method of encoding a motion vector according to embodiments;

FIGS. 17 and 18 illustrate a method of encoding a coding group of motion components according to embodiments;

FIG. 19 illustrates a method of encoding a displacement vector using video encoding according to embodiments;

FIG. 20 illustrates transform coefficients of a displacement vector according to embodiments;

FIG. 21 illustrates transform coefficient blocks of a displacement vector according to embodiments;

FIGS. 22 and 23 illustrate packing of transform coefficient blocks of a displacement vector according to embodiments;

FIGS. 24 and 25 illustrate a method of encoding transform coefficients of a displacement vector according to embodiments;

FIG. 26 illustrates a method of encoding transform coefficients according to embodiments;

FIG. 27 illustrates a method of encoding a coding group of transform coefficients according to embodiments;

FIGS. 28 and 29 illustrate a coding group of transform coefficients according to embodiments;

FIG. 30 illustrates a dynamic mesh decoder according to embodiments;

FIGS. 31 and 32 illustrate a method of inversely transforming the coordinate system of a displacement vector according to embodiments;

FIGS. 33 and 34 illustrate a method of decoding a motion vector according to embodiments;

FIGS. 35, 36, 37, and 38 illustrate a method of reconstructing a coding group of motion components according to embodiments;

FIG. 39 illustrates a displacement vector decoder according to embodiments;

FIG. 40 illustrates a method of inversely packing transform coefficients of a displacement vector according to embodiments;

FIGS. 41 and 42 illustrate a method of decoding a displacement vector according to embodiments;

FIGS. 43 and 44 illustrate a method of decoding transform coefficients according to embodiments;

FIG. 45 illustrates a coding group of transform coefficients according to embodiments;

FIGS. 46, 47, and 48 illustrate subblock-based decoding of transform coefficients according to embodiments;

FIG. 49 shows information related to decoding of motion components contained in a bitstream according to embodiments;

FIGS. 50 and 51 show information related to decoding of transform coefficients of displacement vectors contained in a bitstream according to embodiments;

FIG. 52 illustrates a method of transmitting mesh data according to embodiments; and

FIG. 53 illustrates a method of receiving mesh data according to embodiments.

### BEST MODE

Reference will now be made in detail to the preferred embodiments of the present disclosure, examples of which are illustrated in the accompanying drawings. The detailed description, which will be given below with reference to the accompanying drawings, is intended to explain exemplary embodiments of the present disclosure, rather than to show the only embodiments that can be implemented according to the present disclosure. The following detailed description includes specific details in order to provide a thorough understanding of the present disclosure. However, it will be apparent to those skilled in the art that the present disclosure may be practiced without such specific details.

Although most terms used in the present disclosure have been selected from general ones widely used in the art, some terms have been arbitrarily selected by the applicant and their meanings are explained in detail in the following description as needed. Thus, the present disclosure should be understood based upon the intended meanings of the terms rather than their simple names or meanings.

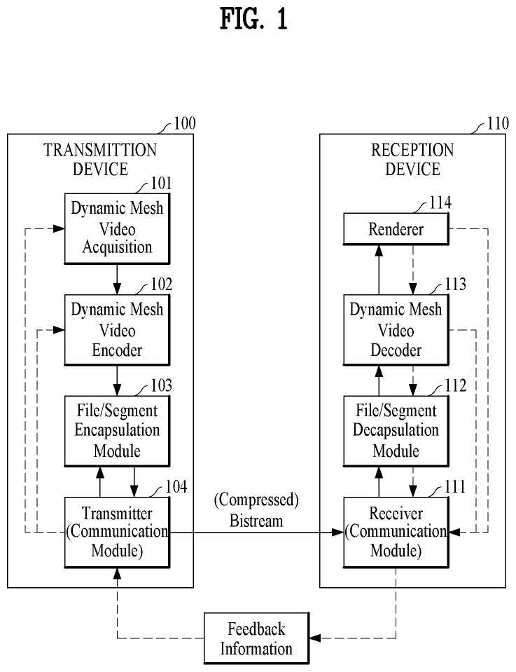

FIG. 1 illustrates a system for providing dynamic mesh content according to embodiments.

The system in FIG. 1 includes a point cloud data transmission device 100 and a point cloud data reception device 110. The point cloud data transmission device may include a dynamic mesh video acquisition unit (or part) 101, a dynamic mesh video encoder 102, a file/segment encapsulator 103, and a transmitter 104. The point cloud data reception device 110 may include a receiver 111, a file/segment decapsulator 112, a dynamic mesh video decoder 113, and a renderer 114. Each component in FIG. 1 may correspond to hardware, software, a processor, and/or a combination thereof. In the following description, a point cloud data transmission device according to embodiments may be interpreted as referring to the transmission device 100 or the dynamic mesh video encoder (hereinafter, encoder) 102. A point cloud data reception device according to embodiments may be interpreted as referring to the reception device 110 or the dynamic mesh video decoder (hereinafter, decoder) 113.

The system of FIG. 1 may perform video-based dynamic mesh compression and decompression.

With advancements in 3D capture, modeling, and rendering, users are allowed to access 3D content in various forms, such as AR, XR, metaverse, and holograms, across multiple platforms and devices. 3D content is increasingly becoming sophisticated and realistic in its representation of objects to provide immersive experiences for users. However, this requires a substantial amount of data for generation and use of 3D models. Among the various types of 3D content, 3D meshes are widely used for efficient data utilization and realistic object representation. Embodiments include a series of processing steps in a system that uses mesh content.

First, the method of compressing dynamic mesh data starts with the Video-based point cloud compression (V-PCC) standard technique. Point cloud data is data that has color information in the coordinates (X, Y, Z) of vertices. Mesh data refers to vertex information including inter-vertex connectivity information. Content may be originally created in the form of mesh data. Connectivity information may be added to point cloud data, and the point cloud data may be transformed into mesh data.

Currently, the MPEG standards group defines two data types for dynamic mesh data: Category 1 of mesh data having a texture map as color information, and Category 2 of mesh data having vertex colors as color information.

Mesh coding standards for Category 1 data are currently underway, and standardization for Category 2 data is expected to follow. The overall process for providing a mesh content service may include acquisition, encoding, transmission, decoding, rendering, and/or feedback processes, as shown in FIG. 1.

To provide mesh content services, 3D data acquired through multiple cameras or special cameras may be processed into a mesh data type through a series of steps to generate a video. The generated mesh video may be transmitted through a series of operations, and the receiving side may process the received data back into a mesh video for rendering. Through this process, the mesh video may be provided to the user, allowing the user to utilize the mesh content interactively according to their intent.

A mesh compression system may include a transmission device and a reception device. The transmission device may encode the mesh video to output a bitstream, which may be delivered to the reception device over a digital storage medium or a network in the form of file or streaming (streaming segments). The digital storage medium may include various storage media such as USB, SD, CD, DVD, Blu-ray, HDD, and SSD.

The transmission device may schematically include a mesh video acquisition unit, a mesh video encoder, and a transmitter. The reception device may schematically include a receiver, a mesh video decoder, and a renderer. The encoder may be referred to as a mesh video/image/picture/frame encoding device. The decoder may be referred to as a mesh video/image/picture/frame decoding device. A transmitter may be included in the mesh video encoder, and a receiver may be included in the mesh video decoder. The renderer may include a display, and the renderer and/or display may be configured as separate devices or external components. The transmission device and reception device may further include separate internal or external modules/units/components for the feedback process.

Mesh data represents the surface of an object using multiple polygons. Each polygon is defined by vertices in 3D space and connectivity information indicating how the vertices are connected. Additionally, vertex attributes such as color and normal vectors may be included in the data. Mapping information, which allows the surface of the mesh to be mapped onto a 2D plane, may also be included in the attributes of the mesh. The mapping is generally described using a set of parametric coordinates related to mesh vertices, referred to as UV coordinates or texture coordinates. A mesh contains a 2D attribute map, which may be used to store high-resolution attribute information such as texture, normal, and displacement.

The mesh video acquisition unit may include processing 3D object data acquired through a camera or the like into a mesh data type having the attributes described above through a series of operations and generating a video composed of the mesh data. In the mesh video, the attributes of the mesh, such as vertices, polygons, connectivity between vertices, color, and normal, may change over time. A mesh video with attributes and connectivity information that change over time is referred to as a dynamic mesh video.

The mesh video encoder may encode an input mesh video into one or more video streams. A video may contain multiple frames, each of which may correspond to a still image/picture. In the present disclosure, the mesh video may include mesh images/frames/pictures. The term “mesh video” may be used interchangeably with mesh images/frames/pictures. The mesh video encoder may perform a Video-based Dynamic Mesh (V-Mesh) compression procedure. For compression and coding efficiency, the mesh video encoder may perform a series of procedures such as prediction, transformation, quantization, and entropy coding. Encoded data (encoded video/image information) may be output in the form of a bitstream.

The encapsulation processor (file/segment encapsulation module) may encapsulate encoded mesh video data and/or mesh video-related metadata in the form of a file or the like. The mesh video-related metadata may be received from a metadata processor. The metadata processor may be included in the mesh video encoder, or may be configured as a separate component/module. The encapsulation processor may encapsulate the data into a file format such as ISOBMFF or process the same into forms such as DASH segments. According to embodiments, the encapsulation processor may include the mesh video-related metadata in the file format. For example, the mesh video metadata may be included in boxes at various levels in the ISOBMFF file format, or as data on separate tracks in the file. In some embodiments, the encapsulation processor may encapsulate the mesh video-related metadata into a file.

The transmission processor may apply processing to the encapsulated mesh video data for transmission based on the file format. The transmission processor may be included in the transmitter or implemented as a separate component/module. The transmission processor may process the mesh video data according to any transmission protocol. The processing for transmission may include processing for delivery over a broadcast network and processing for delivery over a broadband. In some embodiments, the transmission processor may receive mesh video-related metadata from the metadata processor, as well as the mesh video data, and process the same for transmission.

The transmitter may transmit the encoded video/image information or data output in bitstream form to the receiver of the reception device over a digital storage medium or network in the form of a file or streaming. The digital storage medium may include various storage media such as USB, SD, CD, DVD, Blu-ray, HDD, and SSD. The transmitter may include an element to generate a media file through a predetermined file format, and may include an element for transmission over a broadcast/communication network. The receiver may extract the bitstream and deliver the same to a decoding device.

The receiver may receive the mesh video data transmitted by the mesh video transmission device. Depending on the channel for transmission, the receiver may receive the mesh video data over a broadcast network or a broadband network, or may receive the mesh video data over a digital storage medium.

The reception processor may perform processing on the received mesh video data according to the transmission protocol. The reception processor may be included in the receiver, or may be configured as a separate component/module. To correspond to the processing performed for transmission on the transmitting side, the reception processor may perform the reverse process to the operations of the transmission processor described above. The reception processor may deliver the acquired mesh video data to the decapsulation processor and the acquired mesh video-related metadata to the metadata parser. The mesh video-related metadata acquired by the reception processor may be in the form of a signaling table.

The decapsulation processor (file/segment decapsulation module) may decapsulate mesh video data in the form of files received from the reception processor. The decapsulation processor may decapsulate the files according to ISOBMFF or the like to acquire a mesh video bitstream or mesh video-related metadata (metadata bitstream). The acquired mesh video bitstream may be delivered to the mesh video decoder, and the acquired mesh video-related metadata (metadata bitstream) may be delivered to the metadata processor. The mesh video bitstream may include metadata (metadata bitstream). The metadata processor may be included in the mesh video decoder, or may be configured as a separate component/module. The mesh video-related metadata acquired by the decapsulation processor may be in the form of boxes or tracks in the file format. The decapsulation processor may receive metadata required for decapsulation from the metadata processor, when necessary. The mesh video-related metadata may be delivered to the mesh video decoder for use in the mesh video decoding procedure, or to the renderer for use in the mesh video rendering procedure.

The mesh video decoder may receive the input bitstream and perform an operation corresponding to the operation of the mesh video encoder to decode the video/images. The decoded mesh video/images may be displayed through the display of the renderer. The user may view all or a portion of the rendered result through a VR/AR display, a general display, or the like.

The feedback process may include transmitting various kinds of feedback information that may be acquired during the rendering/display operation to the transmitting side or to the decoder on the receiving side. The feedback process may provide interactivity in consuming the mesh video. In some embodiments, the feedback process may include transmitting head orientation information, viewport information indicative of an area the user is currently viewing, and the like. In some embodiments, the user may interact with objects implemented in the VR/AR/MR/autonomous driving environment. In this case, the information related to the interaction may be delivered to the transmitting side or service provider during the feedback process. In some embodiments, the feedback process may be skipped.

The head orientation information may refer to information about the user's head position, angle, movement, etc. Based on this information, information about the area that the user is currently viewing within the mesh video, i.e., viewport information, may be calculated.

The viewport information may be information about the area in the mesh video that the user is currently viewing. Gaze analysis may be performed based on this information to determine how the user consumes the mesh video, how long the user is looking at a particular area of the mesh video, and the like. The gaze analysis may be performed on the receiving side and the result may be delivered to the transmitting side through a feedback channel. A device, such as a VR/AR/MR display, may extract a viewport area based on the user's head position/orientation, the vertical or horizontal FOV supported by the device, etc.

In some embodiments, the feedback information described above may not only be delivered to the transmitter, but may also be consumed on the receiving side. In other words, operations such as decoding and rendering may be performed on the receiving side based on the feedback information described above. For example, based on the head orientation information and/or viewport information, only the mesh video for the area currently being viewed by the user may be preferentially decoded and rendered.

The present disclosure relates to dynamic mesh video compression as described above. The methods/embodiments disclosed herein may be applied to the standard of Video-based Dynamic mesh compression (V-Mesh) of the Moving Picture Experts Group (MPEG) or any next-generation video/image coding standard. Dynamic mesh video compression is a method for processing mesh connectivity information and attributes that change over time. It may perform lossy and lossless compression for a variety of applications such as real-time communications, storage, free-viewpoint video, and AR/VR.

The dynamic mesh video compression method described below is based on the V-mesh method of the MPEG.

In the present disclosure, a picture/frame may generally refer to a unit that represents one image at a specific time.

A pixel or pel may refer to the smallest unit that constitutes a picture (or video). Additionally, the term “sample” may be used as a term corresponding to a pixel. A sample may generally indicate a pixel or the value of the pixel in general. It may indicate only the pixel/pixel value of the luma component, or may indicate only the pixel/pixel value of the chroma component, or may indicate only the pixel/pixel value of the depth component.

A unit may represent the basic unit of image processing. The unit may include at least one of a specific area of the picture and information related to the region. In some cases, the term unit may be used interchangeably with terms such as block or area. In general, an M×N block may include a set (or array) of samples (or a sample array) or transform coefficients composed of M columns and N rows.

The encoding process of FIG. 1 is performed as follows.

The compression method of Video-based dynamic mesh compression (V-Mesh) may provide a method of compressing dynamic mesh video data based on 2D video codecs such as High Efficiency Video Coding (HEVC) and Versatile Video Coding (VVC). In the V-Mesh compression process, the following data is received as input and compressed.

Input mesh: Includes 3D coordinates (geometry) of the vertices comprising the mesh, normal information about each vertex, mapping information for mapping the surface of the mesh to a 2D plane, and connectivity between the vertices constituting the surface. The surface of the mesh may be represented by triangles or other polygons, and the connectivity information between the vertices constituting the surface is stored according to a predetermined shape. The input mesh may be stored in the OBJ file format.

Attribute map (Texture map is also used interchangeably hereafter): Contains information about the attributes (color, normals, displacements, etc.) of a mesh and stores the data in the form of a mapping of the surface of the mesh onto a 2D image. Mapping indicating which part (surface or vertex) of the mesh corresponds to each piece of data in the attribute map is based on the mapping information contained in the input mesh. Since the attribute map has data about each frame of the mesh video, it may also be referred to as an attribute map video (or simply as attributes). The attribute map in the V-Mesh compression method mainly contains the color information about the mesh and is stored in an image file format (PNG, BMP, etc.).

Material library file: Contains the material attribute information used in the mesh, specifically the information that links the input mesh to the corresponding attribute map. It is stored in the Wavefront Material Template Library (MTL) file format.

In the V-Mesh compression method, the following data and information may be generated through the compression process.

Base mesh: Represents the objects in the input mesh using the minimum vertices determined according to the user's criteria by decimating the input mesh through the pre-processing process.

Displacement: Displacement information used to represent the input mesh as similarly as possible using the base mesh, expressed in 3D coordinates.

Atlas information: Metadata needed to reconstruct a mesh using the base mesh, displacement, and attribute map information. It may be generated and utilized in sub-units (sub-mesh, patch, etc.) that constitute the mesh.

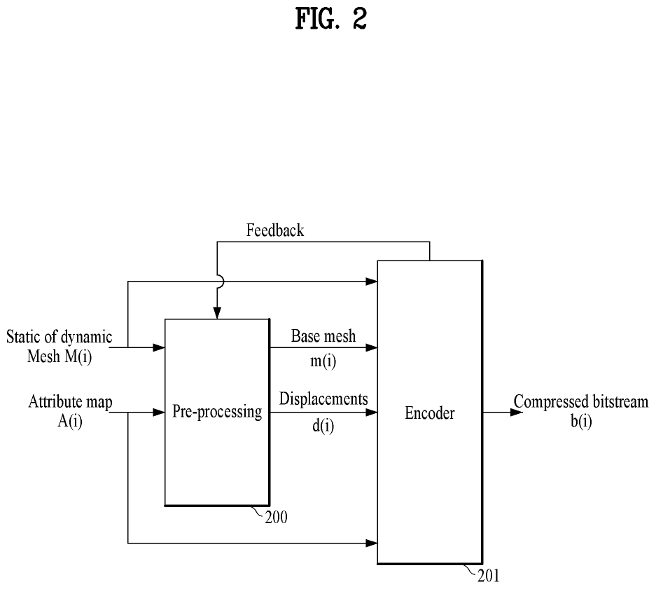

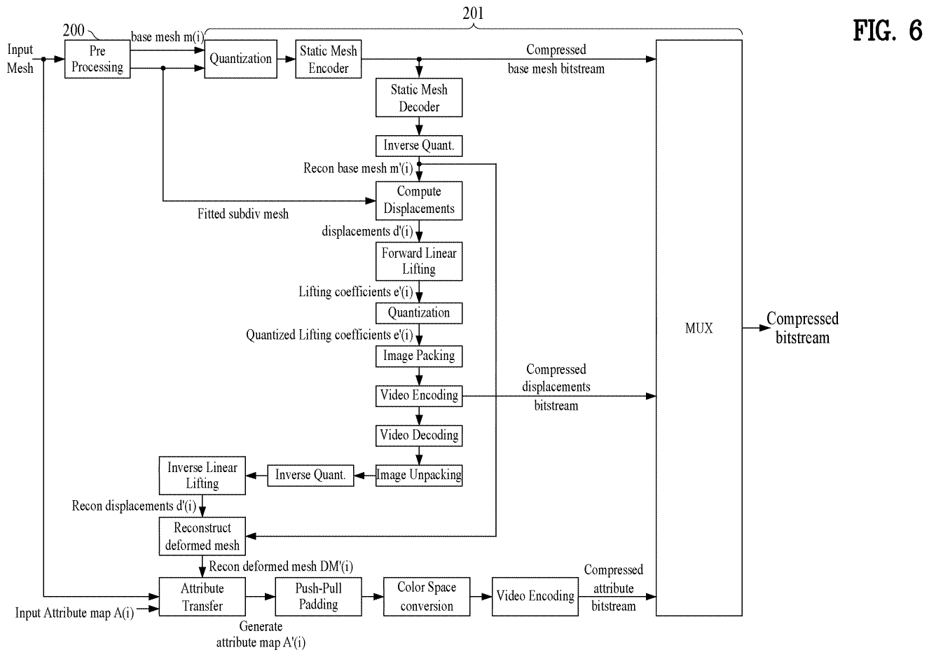

A method of encoding mesh position information (or vertex) is described with reference to FIGS. 2 to 7, and a method of reconstructing mesh position information to encode attribute information (attribute map) is described with reference to FIGS. 6 to 10 and the like.

FIG. 2 illustrates a V-MESH compression method according to embodiments.

FIG. 2 illustrates the encoding process of FIG. 1, wherein the encoding process may include a pre-processing process and an encoding process. The encoder of FIG. 1 may include a pre-processor 200 and an encoder 201, as shown in FIG. 2. The transmission device of FIG. 1 may be broadly referred to as an encoder, and the dynamic mesh video encoder of FIG. 1 may be referred to as an encoder. The V-Mesh compression method may include pre-processing and encoding 201, as shown in FIG. 2. The pre-processor of FIG. 2 may be positioned at the front end of the encoder of FIG. 2. The pre-processor and encoder of FIG. 2 may be referred to as a single encoder.

The pre-processor may receive a static dynamic mesh and/or an attribute map. The pre-processor may generate a base mesh and/or displacements through pre-processing. The pre-processor may receive feedback information from the encoder, and may generate the base mesh and/or displacements based on the feedback information.

The encoder may receive the base mesh, the displacements, the static dynamic mesh, and/or the attribute map. The encoder may encode the mesh-related data to generate a compressed bitstream.

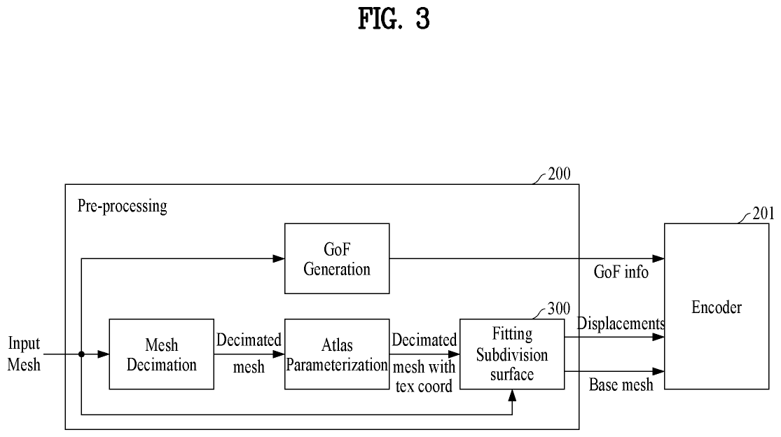

FIG. 3 illustrates pre-processing in V-MESH compression according to embodiments.

FIG. 3 illustrates the configuration and operation of the pre-processor of FIG. 2.

FIG. 3 illustrates the process of performing pre-processing on the input mesh. The pre-processing 200 may include four operations: 1) Group of Frame (GoF) generation, 2) mesh decimation, 3) UV parameterization, and 4) fitting subdivision surface (300). The pre-processor 200 may receive input mesh, generate displacements and/or a base mesh, and deliver the same to the encoder 201. The pre-processor 200 may deliver GoF information related to the GoF generation to the encoder 201.

Hereinafter, each operation in FIG. 3 is described.

GoF generation: A process of generating a reference structure for the mesh data. When the mesh of the previous frame and the current mesh have the same number of vertices, same number of texture coordinates, same vertex connectivity information, and same texture coordinate connectivity information, the previous frame may be set as a reference frame. In other words, if only the vertex coordinate values are different between the current input mesh and the reference input mesh, inter frame encoding may be performed. Otherwise, the frame may be subjected to intra frame encoding.

Mesh decimation: A process of simplifying the input mesh to create a simplified mesh, called a base mesh. Vertices to remove may be selected from the original mesh based on user-defined criteria, and then the selected vertices and the triangles connected to the selected vertices may be removed.

In the process of performing mesh decimation, the voxelized input mesh, target triangle ratio (TTR), and minimum triangle component (CCCount) information may be delivered as input, and the decimated mesh may be obtained as output. In the process, connected triangle components that are smaller than the set minimum triangle component (CCCount) may be removed.

UV parameterization: A process of mapping a 3D curved surface into a texture domain for the decimated mesh. Parameterization may be performed using the UVAtlas tool. This process generates mapping information indicating where each vertex of the decimated mesh may be mapped to on the 2D image. The mapping information is expressed and stored as texture coordinates, and the final base mesh is generated through this process.

Fitting subdivision surface: An operation of performing subdivision on the decimated mesh. A user-defined method, such as the mid-edge method, may be applied as the subdivision method. A fitting process is performed such that the input mesh and the subdivided mesh become similar to each other.

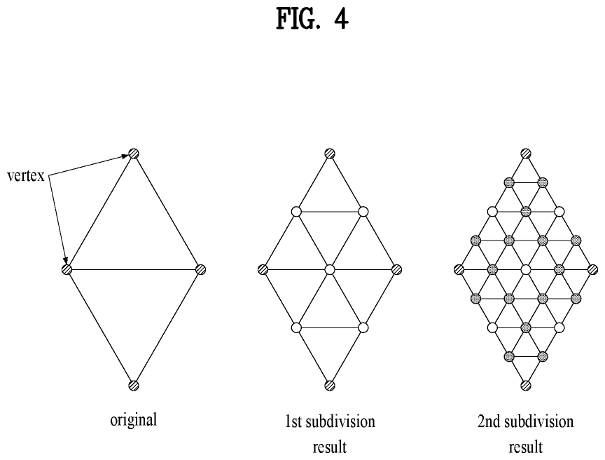

FIG. 4 illustrates a mid-edge subdivision method according to embodiments.

FIG. 4 illustrates a mid-edge subdivision method for the fitting subdivision surface described with reference to FIG. 3. Referring to FIG. 4, the original mesh containing four vertices is subdivided to create sub-meshes. The sub-meshes may be created by creating new vertices in the middle of the edges between the vertices.

Once the fitted subdivided mesh is generated, the displacements are calculated based on this result and the previously compressed and decoded base mesh (hereinafter referred to as the reconstructed base mesh). In other words, the reconstructed base mesh is subdivided in the same way as the fitting subdivision surface. The difference in position between this result and each vertex in the fitted subdivided mesh is the displacement for each vertex. Since the displacement represents a difference in position in 3D space, it is expressed as values in (x, y, z) space in the Cartesian coordinate system. Depending on a user input parameter, the coordinate values of (x, y, z) may be converted to coordinate values of (normal, tangential, bi-tangential) in a local coordinate system.

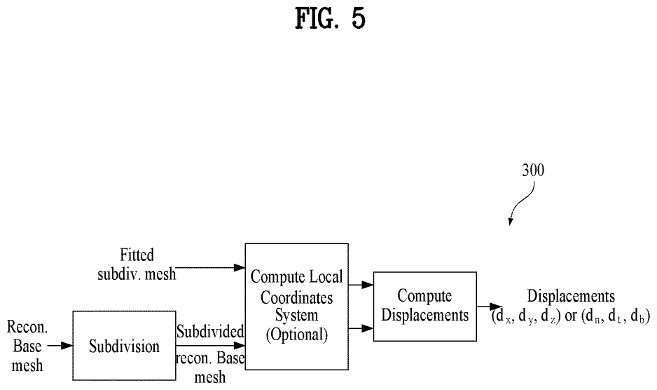

FIG. 5 illustrates a displacement generation process according to embodiments.

FIG. 5 illustrates in detail how displacements are calculated for the fitting subdivision surface 300, as described with reference to FIG. 4.

The encoder and/or pre-processor according to the embodiments may include 1) a subdivider, 2) a local coordinate system calculator, and 3) a displacement vector calculator. The subdivider may receive a reconstructed base mesh and generate a subdivided reconstructed base mesh. The local coordinate system calculator may receive the fitted subdivided mesh and the subdivided reconstructed base mesh, and may transform the coordinate system related to the mesh to a local coordinate system. The local coordinate system calculation may be optional. The displacement calculator calculates the difference in position between the fitted subdivision mesh and the subdivided reconstructed base mesh. For example, it may generate the difference in position between the vertices in the two input meshes. The difference in position between the vertices is the displacement.

The point cloud data transmission method and device according to embodiments may encode the point cloud as follows. Point cloud data (which may be referred to as a point cloud for short) according to embodiments may refer to data including vertex coordinates and color information. Point cloud is a term that includes mesh data. The terms point cloud and point cloud data may be used interchangeably herein.

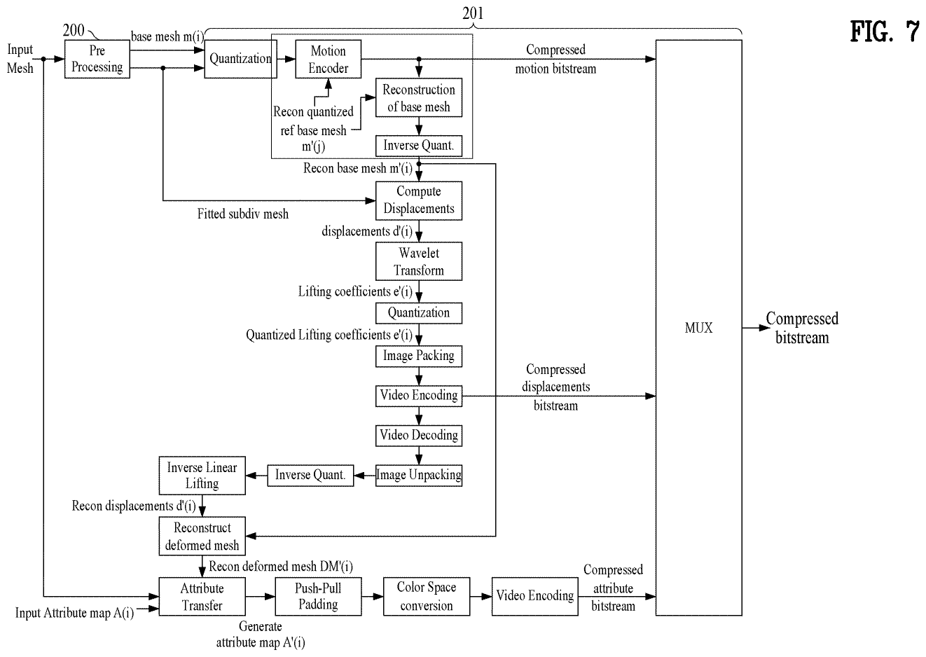

According to embodiments, the V-Mesh compression (reconstruction) method may include intra frame encoding (FIG. 6) and inter frame encoding (FIG. 7).

Based on the results of the GoF generation described above, intra frame encoding or inter frame encoding is performed. In the intra encoding, the data to be compressed may be a base mesh, displacements, an attribute map, and the like. In the inter encoding, the data to be compressed may be displacements, an attribute map, and a motion field between the reference base mesh and the current base mesh.

FIG. 6 illustrates an intra-frame encoding process in a V-MESH compression method according to embodiments.

The encoding process of FIG. 6 details the encoding of FIG. 1. That is, it represents the configuration of the encoder when the encoding of FIG. 1 is intra-frame encoding. The encoder of FIG. 6 may include a pre-processor 200 and/or an encoder 201.

The pre-processor may receive an input mesh and perform the pre-processing described above. A base mesh and/or a fitted subdivided mesh may be generated through the pre-processing. The quantizer may quantize the base mesh and/or the fitted subdivided mesh. The static mesh encoder may encode the static mesh. The static mesh encoder may generate a bitstream containing the encoded base mesh. The static mesh decoder may decode the encoded static mesh. The inverse quantizer may inversely quantize the quantized static mesh. The displacement calculator may receive a reconstructed static mesh, and may generate a displacement, which is the difference in position based on the fitted subdivided mesh. The forward linear lifting unit may receive the displacement and generate lifting coefficients. The quantizer may quantize the lifting coefficients. The image packer may pack the image based on the quantized lifting coefficients. The video decoder decodes the encoded video. The image unpacker may unpack the packed image. The inverse quantizer may inversely quantize the image. The inverse linear lifting unit applies inverse lifting to the image to generate a reconstructed displacement. The mesh reconstructor reconstructs a deformed mesh based on the reconstructed displacement and the reconstructed base mesh. The attribute transfer receives an input mesh and/or an input attribute map and generates an attribute map based on the reconstructed deformed mesh. The push-pull padding unit may pad data to the attribute map based on a push-pull method. The color space converter may convert the space of the color component, which is an attribute. The video encoder may encode the attribute. The multiplexer may multiplex the compressed base mesh, the compressed displacement, and the compressed attribute to generate a bitstream.

FIG. 7 illustrates an inter-frame encoding process in a V-MESH compression method according to embodiments.

The encoding process of FIG. 7 details the encoding of FIG. 1 in detail. That is, it represents the configuration of the encoder when the encoding of FIG. 1 is inter-frame encoding. The encoder of FIG. 7 may include a pre-processor 200 and/or an encoder 201.

For the components of the encoding operation of FIG. 7 that correspond to the encoding operation of FIG. 6, refers to the description of FIG. 7. For inter-frame-based encoding in FIG. 7, the motion encoder may encode a motion based on the reconstructed quantized reference base mesh. The base mesh reconstructor may reconstruct a base mesh based on the reconstructed quantized reference base mesh.

The encoder in FIG. 6 compresses the base mesh, displacement, and attributes within a frame to generate a bitstream, while the encoder in FIG. 7 compresses the motion, displacement, and attributes between the current frame and a reference frame to generate a bitstream.

The encoding method according to the embodiments includes base mesh encoding (intra encoding). When performing intra-frame encoding on a current input mesh frame, the base mesh generated during pre-processing may undergo quantization and be then encoded using a static mesh compression technique. In the V-Mesh compression method, for example, the Draco technique is applied, and the targets to be compressed include vertex position information, mapping information (texture coordinates), vertex connectivity data, etc. related to the base mesh.

The encoding method according to the embodiments may include motion field encoding (also inter encoding). Inter frame encoding may be performed when the reference mesh and the current input mesh have a one-to-one correspondence of vertices, and only the position information about the vertices differs therebetween. When inter frame encoding is performed, the base mesh may not be compressed. Instead, the difference between the vertices of the reference base mesh and the current base mesh, i.e., the motion field may be computed and encoded. The reference base mesh is the result of quantizing the decoded base mesh data and is determined by the reference frame index determined in the GoF generation. The motion field may be encoded as it is. Alternatively, a predicted motion field may be calculated by averaging the motion fields of the reconstructed vertices among the vertices connected to the current vertex, and a residual motion field, which is the difference between the value of the predicted motion field and the value of the motion field of the current vertex, may be encoded. The value of this field may be encoded using entropy coding. Except for the motion field encoding in the inter frame encoding, the process of encoding the displacements and attribute map is the same as the structure of the intra frame encoding method except for the base mesh encoding.

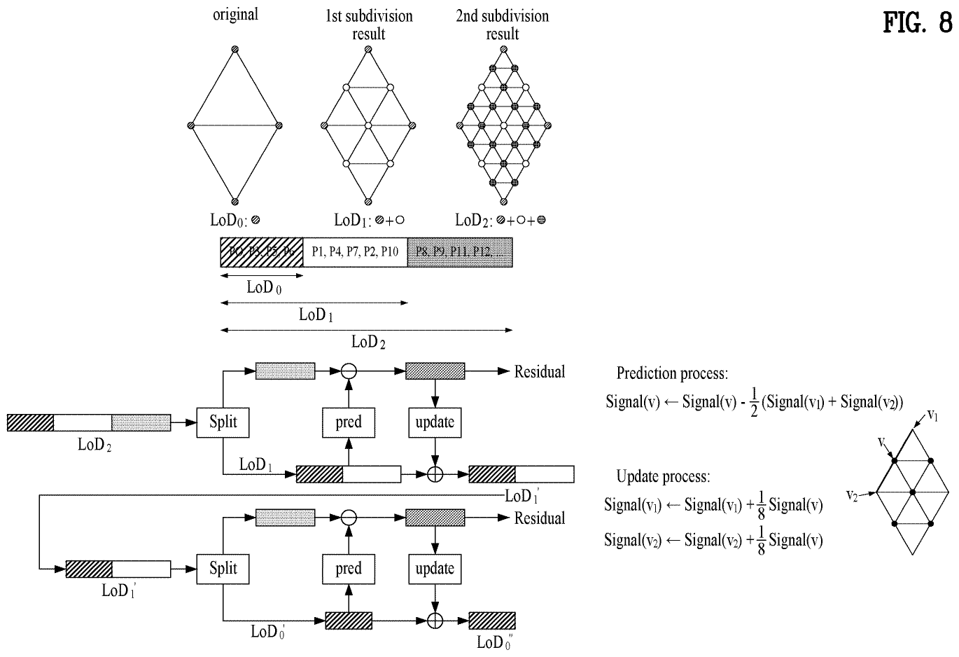

FIG. 8 illustrates a lifting transform process for displacements according to embodiments.

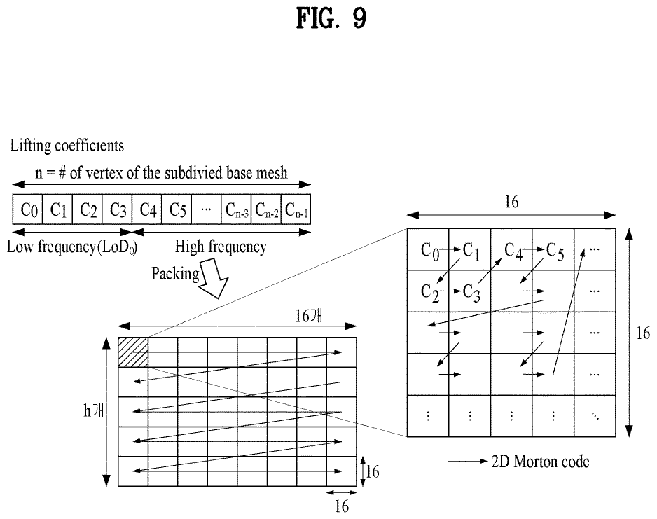

FIG. 9 illustrates a process of packing transform coefficients into a 2D image according to embodiments.

FIGS. 8 and 9 illustrate the process of transforming displacements and packing transform coefficients in the encoding process of FIGS. 6 and 7, respectively.

An encoding method according to the embodiments includes displacement encoding.

After base mesh encoding and/or motion field encoding, a reconstructed base mesh may be generated through reconstruction and inverse quantization, and a displacement may be calculated between a result of subdivision of the reconstructed base mesh and a fitted subdivided mesh generated through the fitting subdivision surface. A data transform process, such as a wavelet transform, may be applied to the displacement information for effective encoding.

FIG. 8 illustrates the process of transforming displacement information in V-Mesh using the lifting transform. The transform coefficients generated through the transform process are quantized and then packed into a 2D image. The transform coefficients may be organized into blocks, one block for every 256 (=16×16) units. Each block may be packed in a z-scan order. The number of rows in a block is fixed to 16, but the number of columns in the block may be determined by the number of vertices in the subdivided base mesh. Within a block, the transform coefficients may be sorted with the Morton code and packed. For the packed images, a displacement video may be generated per GoF. The displacement video may be encoded using a conventional video compression codec.

Referring to FIG. 8, the base mesh (original) may include vertices and edges for LoD0. A first subdivision mesh generated by splitting the base mesh includes vertices generated by further splitting the edges of the base mesh. The first subdivision mesh contains vertices for LoD0 and vertices for LoD1. LoD1 includes subdivided vertices and vertices from the base mesh (LoD0). The first subdivision mesh may be split to generate a second subdivision mesh. The second subdivision mesh contains LoD2. LoD2 includes a base mesh vertex (LoD0), LoD1 containing vertices additionally generated from LoD0, and vertices further split from LoD1. LoD is a level of detail that indicates the degree of detail. As the index of the level increases, the distance between vertices is shortened, and the level of detail rises. LoD N contains the vertices contained in LoD N−1. In the case where the vertex is further split through subdivision, the mesh may be encoded based on a prediction and/or updating method, taking into account the previous vertices v1 and v2, and the subdivided vertex v. Instead of encoding the information for the current LoD N as it is, a residual with respect to previous LoD N−1 may be generated. Thus, the mesh may be encoded using the residual to reduce the size of the bitstream. The prediction process refers to the operation of predicting the current vertex v from the previous vertices v1 and v2. Since neighboring subdivision meshes have similar data, this property may be exploited for efficient encoding. The current vertex position information is predicted from the residual for the previous vertex position information, and the previous vertex position information is updated based on the residual.

Referring to FIG. 9, a vertex has a coefficient generated through lifting transform. The coefficient of the vertex related to the lifting transform may be packed into an image and then encoded.

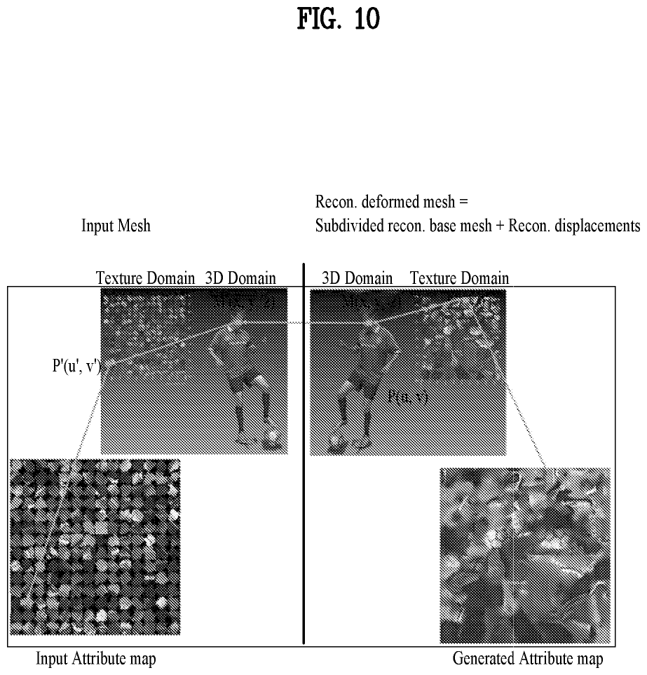

FIG. 10 illustrates an attribute transfer process in a V-MESH compression method according to embodiments.

FIG. 10 illustrates a detailed operation of the attribute transfer in the encoding of FIGS. 6, 7, etc.

The encoding according to the embodiments includes attribute map encoding.

Information about the input mesh is compressed through base mesh encoding, motion field encoding, and displacement encoding. The input mesh compressed in the encoding process is reconstructed through base mesh decoding (intra frame), motion field decoding (inter frame), and displacement video decoding, and the reconstructed deformed mesh (hereinafter referred to as Recon. deformed mesh), which is the result of the reconstruction, is used to compress the input attribute map, as shown in FIGS. 6 and 7. The Recon. deformed mesh has position information about vertices, texture coordinates, and corresponding connectivity information, but does not have color information corresponding to the texture coordinates. Therefore, as shown in FIG. 10, in the V-Mesh compression method, a new attribute map having color information corresponding to the texture coordinates of the recon. deformed mesh is generated through the attribute transfer process.

The attribute transfer first checks, for every point P(u, v) in the 2D texture domain, whether the corresponding point is within a texture triangle of the Recon. deformed mesh. When the corresponding vertex is in the texture triangle T, the attribute transfer calculates the barycentric coordinates (α, β, γ) of P(u, v) according to the triangle T. Then, it calculates the 3D coordinates M(x, y, z) of P(u, v) based on the 3D vertex positions of the triangle T and (α, β, γ). The vertex coordinates M′(x′, y′, z′) that corresponds to the closest position to the calculated M(x, y, z) and a triangle T′ containing this point are searched for in the input mesh domain. Then, the barycentric coordinates (α′, β′, γ′) of M′(x′, y′, z′) in the triangle T′ are calculated. The texture coordinates (u′, v′) are calculated based on the texture coordinates corresponding to the three vertices of triangle T′ and (α′, β′, γ′), and the color information corresponding to the coordinates are searched for in the input attribute map. The color information found in this way is then assigned to the (u, v) pixel position in the new input attribute map. If P(u, v) does not belong to any triangle, the pixel at the position in the new input attribute map be filled with a color value using a padding algorithm, such as the push-pull algorithm.

The new attribute map generated by the attribute transfer is bundled into GoFs to construct an attribute map video, which is compressed using a video codec.

A reference relationship between the input mesh, the input attribute map, the reconstructed mesh, and the generated attribute map may be seen from FIG. 10.

The decoding process of FIG. 1 may perform the reverse of the encoding process of FIG. 1. Specifically, the decoding process is performed as disclosed below.

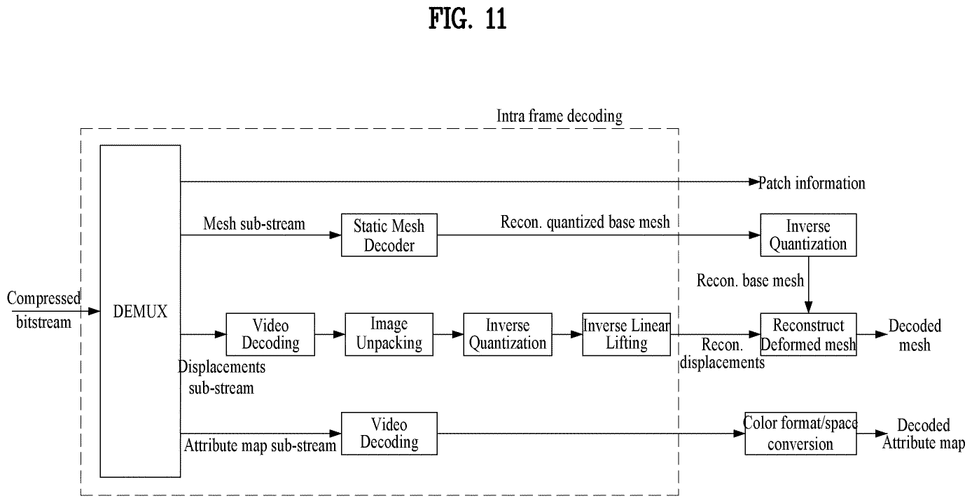

FIG. 11 shows the intra-frame decoding process of the V-MESH compression method according to embodiments.

FIG. 11 illustrates the configuration and operation of the decoder of the reception device of FIG. 1 and the like.

FIG. 11 shows the intra decoding process of the V-Mesh technology according to embodiments. First, the bitstream may be separated into a mesh sub-stream, a displacement sub-stream, an attribute map sub-stream, and a sub-stream containing patch information about the mesh, such as V3C/V-PCC.

The mesh sub-stream may be decoded through the decoder of a static mesh codec used in the encoding such as, for example, Google Draco. As a result, connectivity information, vertex geometry information, vertex texture coordinates, and the like related to the base mesh may be reconstructed. The displacement sub-stream may be decoded into a displacement video through the decoder of the video compression codec used in the encoding. Then, image unpacking, inverse quantization, and inverse transform are performed to reconstruct the displacement information about each vertex. Then, inverse quantization is applied to the reconstructed base mesh, and then the result thereof is combined with the reconstructed displacement information to generate a final decoded mesh.

The attribute map sub-stream is decoded by the decoder of the video compression codec used in the encoding, and then a final attribute map is reconstructed through color format transform and the like.

The reconstructed decoded mesh and decoded attribute map may be utilized at the receiving side as final mesh data that may be utilized by a user.

Referring to FIG. 11, the bitstream includes patch information, a mesh sub-stream, a displacement sub-stream, and an attribute map sub-stream. The term sub-stream is interpreted as referring to a partial bitstream included in the bitstream. The bitstream contains patch information (data), mesh information (data), displacement information (data), and attribute map information (data).

The decoder performs intra-frame decoding as follows. The static mesh decoder decodes the mesh to generate a reconstructed quantized base mesh, and the inverse quantizer applies the quantization parameters of the quantizer in reverse to generate a reconstructed base mesh. The video decoder decodes the displacement, the unpacker unpacks the decoded video image, and the inverse quantizer inversely quantizes the quantized image. The inverse linear lifting unit applies a lifting transform in the reverse process of the encoder to generate a reconstructed displacement. The mesh reconstructor 630 generates a deformed mesh based on the base mesh and the displacement. The video decoder decodes the attribute map, and the color transformer transforms the color format and/or space to generate a decoded attribute map.

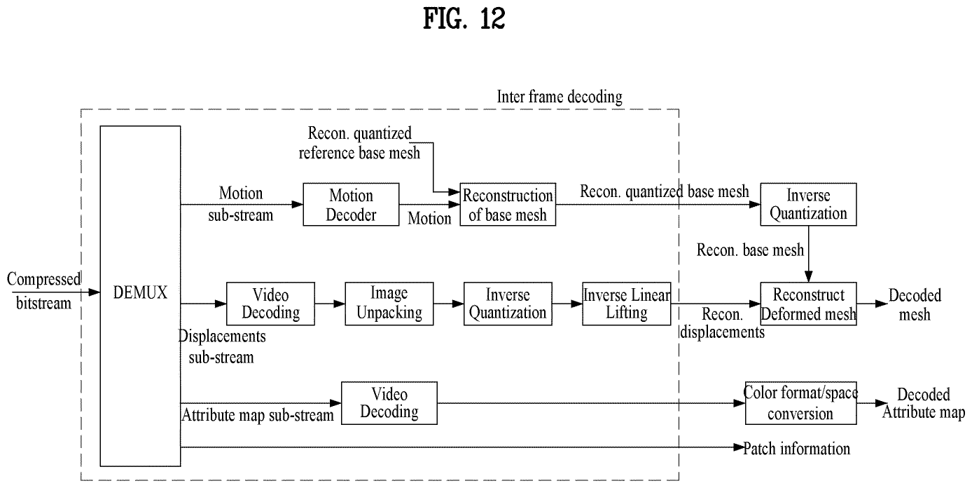

FIG. 12 illustrates an inter-frame decoding process of V-MESH technology.

FIG. 12 illustrates the configuration and operation of the decoder of the reception device of FIG. 1 and the like.

FIG. 12 illustrates the inter decoding process of V-MESH technology. First, the input bitstream may be separated into a motion sub-stream, a displacement sub-stream, an attribute sub-stream, and a sub-stream containing patch information about the mesh, such as V3C/V-PCC.

The motion sub-stream is decoded through entropy decoding and inverse prediction, and the reconstructed motion information is combined with a pre-reconstructed and stored reference base mesh to generate a reconstructed quantized base mesh for the current frame. Then, inverse quantization is applied to the reconstructed quantized base mesh, and the result thereof is combined with the displacement information reconstructed using the same method as the above-described intra decoding to generate a final decoded mesh. The reconstructed decoded mesh and the decoded attribute map may be utilized at the receiving side as the final mesh data that may be utilized by the user.

Referring to FIG. 12, the bitstream contains a motion, displacements, and an attribute map. Because inter-frame decoding is performed, the process further includes decoding the inter-frame motion information. A reconstructed base mesh is generated by decoding the motion and generating a reconstructed quantized base mesh for the motion based on the reference base mesh. For the operations in FIG. 12 that are the same as those in FIG. 11, refer to the description of FIG. 11.

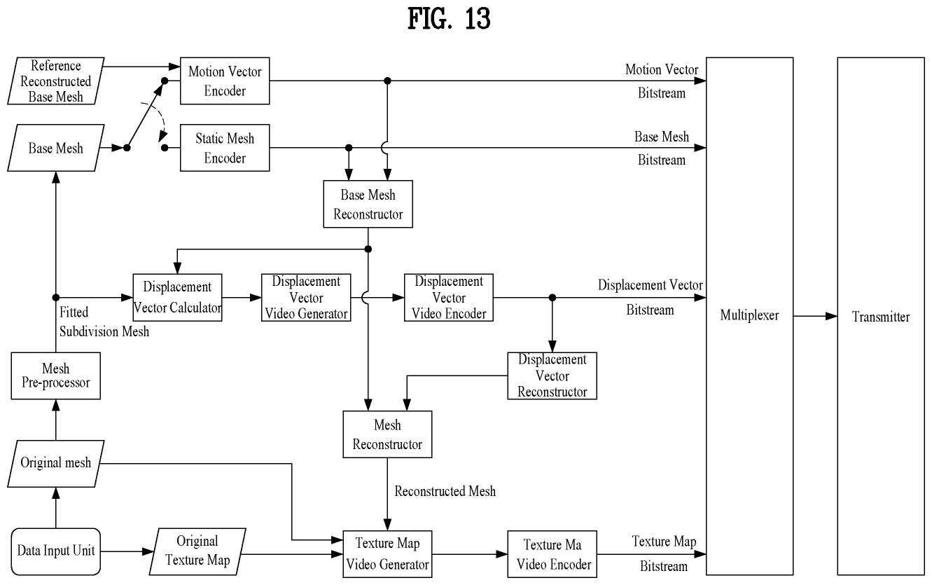

FIG. 13 illustrates a point cloud data transmission device according to embodiments.

FIG. 13 corresponds to the transmission device 100 or dynamic mesh video encoder 102 of FIG. 1, the encoder (pre-processor and encoder) of FIG. 2, and/or the corresponding transmission encoding device. Each component of FIG. 13 corresponds to hardware, software, a processor, and/or a combination thereof.

The process of operations at the transmitting side for compressing and transmitting dynamic mesh data using a V-Mesh compression technique may be configured as shown in FIG. 13.

The mesh pre-processor receives the original mesh and generates a decimated mesh. The decimation may be performed based on a target number of vertices or a target number of polygons constituting the mesh. Parameterization may be performed on the decimated mesh to generate texture coordinates and texture connectivity information per vertex. The mesh information in a floating-point form may be quantized to a fixed-point form. The result is the base mesh, which may be encoded by a static mesh encoder. The mesh pre-processor may perform a mesh subdivision on the base mesh to generate additional vertices. Depending on the subdivision method, vertex connectivity information including the additional vertices, texture coordinates, and connectivity information about the texture coordinates may be generated. A fitted subdivided mesh may be generated by adjusting vertex positions such that the subdivided mesh becomes similar to the original mesh.

When intra-frame encoding (intra encoding) is performed on the mesh frame, the base mesh may be compressed through the static mesh encoder. In this case, the connectivity information, vertex geometry information, vertex texture information, normal information, and the like related to the base mesh may be encoded. The base mesh bitstream generated through the encoding is transmitted to the multiplexer.

When inter-frame encoding (inter encoding) is performed on the mesh frame, the motion vector encoder may operate to receive as input a base mesh and a reference reconstructed base mesh, compute a motion vector between the two meshes, and encode the value thereof. Further, the motion vector encoder may perform connectivity information-based prediction using the previously encoded/decoded motion vector as a predictor, and encode a residual motion vector, which is obtained by subtracting the predicted motion vector from the current motion vector. The motion vector bitstream generated by the encoding is transmitted to the multiplexer.

A reconstructed base mesh may be generated from the encoded base mesh and motion vectors through the base mesh reconstructor.

The displacement vector calculator may perform mesh subdivision on the reconstructed base mesh. A vector may be calculated as a value of the difference in vertex position between the subdivided reconstructed base mesh and the fitted subdivision mesh generated by the pre-processor. As a result, displacement vectors as many as vertices in the subdivided mesh may be calculated. The displacement vector calculator may transform the displacement vectors calculated in the 3D Cartesian coordinate system to a local coordinate system based on the normal vector of each vertex.

The displacement vector video generator may transform the displacement vectors for effective encoding. According to embodiments, the transform may be lifting transform, wavelet transform, or the like. In addition, quantization may be performed on the transformed displacement vector values, i.e., the transform coefficients. In this case, different quantization parameters may be applied to the axes of the transform coefficients, respectively. The quantization parameters may be derived by an agreement between the encoder/decoder. After transform and quantization, the displacement vector information may be packed into a 2D image. A displacement vector video may be generated by grouping the packed 2D images for each frame. A displacement vector video may be generated for each group of frames (GoF) of the input mesh.

The displacement vector video encoder may encode the generated displacement vector video using a video compression codec. The generated displacement vector video bitstream is transmitted to the multiplexer.

The displacement vectors reconstructed through the displacement vector reconstructor and the base mesh reconstructed and subdivided through the base mesh reconstructor are reconstructed through the mesh reconstructor. The reconstructed mesh has reconstructed vertices, inter-vertex connectivity information, texture coordinates, and inter-texture coordinate connectivity information.

A texture map of a reconstructed mesh may re-generated from the texture map of the original mesh through the texture map video generator. The vertex-by-vertex color information in the texture map of the original mesh may be assigned to the texture coordinates of the reconstructed mesh. A texture map video may be generated by grouping the frame-level re-generated texture maps into GoFs.

The generated texture map video may be encoded by the texture map video encoder using a video compression codec. A texture map video bitstream generated through the encoding is transmitted to the multiplexer.

The generated motion vector bitstream, base mesh bitstream, displacement vector bitstream, and texture map bitstream may be multiplexed into a single bitstream to be transmitted to the receiving side through the transmitter. Alternatively, for the generated motion vector bitstream, base mesh bitstream, displacement vector bitstream, and texture map bitstream, a file with one or more track data may be generated or the bitstreams may be encapsulated into segments and transmitted to the receiving side through the transmitter.

Referring to FIG. 13, the transmitter (encoder) may encode the mesh in an intra-frame or inter-frame manner. According to intra-encoding, the transmission device may generate a base mesh, displacement vectors (or displacements), and a texture map (or attribute map). According to inter-encoding, the transmission device may generate a motion vector (or motion), a base mesh, displacement vectors (or displacements), and a texture map (or attribute map). The texture map acquired from the data input unit is generated and encoded based on the reconstructed mesh. The displacements are generated and encoded based on the differences in vertex positions between the base mesh and the subdivided mesh. The base mesh is generated by pre-processing, decimating, and encoding the original mesh. For the motion, a motion vector is generated for the mesh in the current frame based on the reference base mesh in the previous frame.

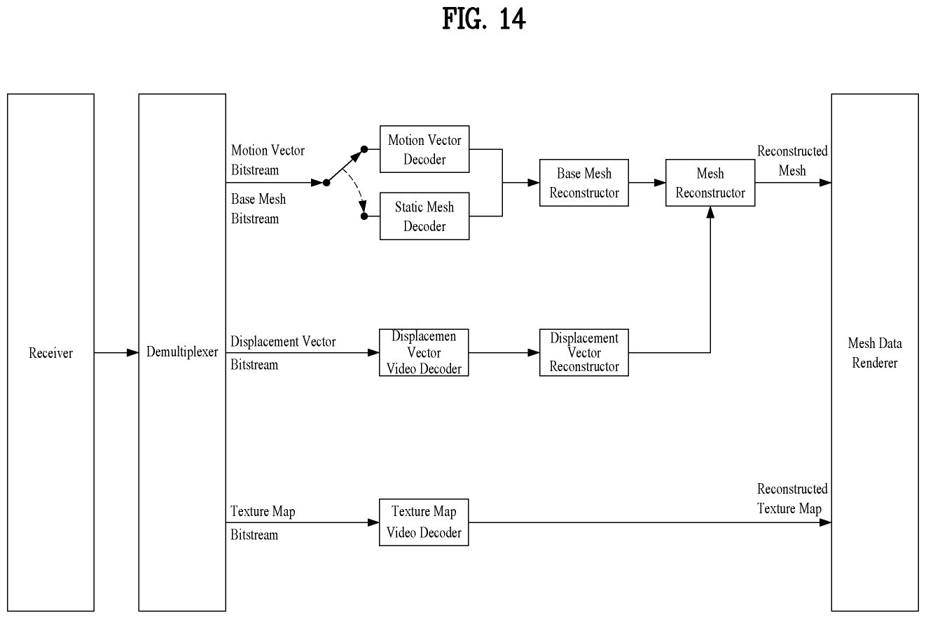

FIG. 14 illustrates a point cloud data reception device according to embodiments.

FIG. 14 corresponds to the reception device 110 or mesh video decoder 113 of FIG. 1, the decoder of FIG. 11 or 12, and/or a corresponding receiving decoding device. Each component of FIG. 14 corresponds to hardware, software, a processor, and/or a combination thereof. The reception (decoding) operation of FIG. 14 may follow a reverse process to the corresponding process of the transmission (encoding) operation of FIG. 13.

The bitstream of the received mesh is subjected to file/segment decapsulation and then demultiplexed into a compressed motion vector bitstream or base mesh bitstream, a displacement vector bitstream, and a texture map bitstream.

In the case where inter-frame encoding is applied to the current mesh based on the frame header information, the motion vector decoder may decode the motion vector bitstream. The previously decoded motion vector may be used as a predictor and add the same to the residual motion vector decoded from the bitstream to reconstruct the final motion vector.

In the case where intra-frame encoding is applied to the current mesh based on the frame header information, the static mesh decoder may decode the base mesh bitstream to reconstruct connectivity information, vertex geometry information, texture coordinates, normal information, and the like related to the base mesh.

In the case where inter-frame encoding is applied to the current mesh, the base mesh reconstructor may add the decoded motion vectors to the reference base mesh and perform inverse quantization to reconstruct the current base mesh. In the case where intra-frame encoding is applied to the current mesh, inverse quantization may be performed on the base mesh decoded by the static mesh decoder to generate a reconstructed base mesh.

The displacement vector video decoder may decode the displacement vector bitstream as a video bitstream using a video codec.

The displacement vector reconstructor extracts displacement vector transform coefficients from the decoded displacement vector video, and reconstructs displacement vectors through inverse quantization and inverse transform. If the reconstructed displacement vectors are values in a local coordinate system, inverse transform to the Cartesian coordinate system may be performed.

The mesh reconstructor may subdivide the reconstructed base mesh to generate additional vertices. Through the subdivision, vertex connectivity information including the additional vertices, texture coordinates, and connectivity information about the texture coordinates may be generated. The subdivided reconstructed base mesh may be combined with the reconstructed displacement vectors to generate a final reconstructed mesh.

The texture map video decoder may decode the texture map bitstream as a video bitstream using a video codec. The reconstructed texture map has color information about each vertex in the reconstructed mesh, and the texture coordinates of each vertex may be used to obtain the color value of the vertex from the texture map.

The reconstructed mesh and texture map are presented to the user through a rendering process using the mesh data renderer or the like.

Referring to FIG. 14, the reception device (decoder) may decode the mesh in an intra-frame or inter-frame manner. According to intra-decoding, the reception device may receive a base mesh, displacement vectors (or displacements), and a texture map (or attribute map), and decode the reconstructed mesh and reconstructed texture map to render mesh data. According to inter-decoding, the reception device may receive a motion vector (or motion), a base mesh, displacement vectors (or displacements), a texture map (or attribute map), and decode the reconstructed mesh and the reconstructed texture map to render mesh data.

A point cloud data transmission device and method according to embodiments may encode mesh data and transmit a bitstream containing the encoded mesh data. A point cloud data reception device and method according to embodiments may receive a bitstream containing mesh data and decode the mesh data. The point cloud data transmission/reception method/device according to the embodiments may be referred to as a method/device for simplicity. The point cloud data transmission/reception method/device according to the embodiments may also be referred to as a mesh data transmission/reception method/device according to the embodiments.

The methods/devices according to the embodiments may include and perform a method for motion vector and displacement coding based on sign bit hiding in V-DMC.

Embodiments relate to video-based dynamic mesh compression (V-DMC), a method of compressing 3D dynamic mesh data using a conventional 2D video codec. In particular, the embodiments include methods for improving compression efficiency when applying arithmetic coding to encode motion vector and displacement vector components. The embodiments may improve the performance of encoding/decoding of dynamic mesh data and thereby enhance usability of dynamic meshes.

The embodiments relate to V-DMC, a method for compressing 3D dynamic mesh data based on a conventional 2D video codec. Specifically, they relate to a motion vector encoding method and a displacement vector encoding method used by the V-DMC encoder. They relate to a method of improving encoding performance by applying a sign bit hiding technique when encoding motion vector and displacement vector components using arithmetic coding. They also relate to a method of decoding each datum from bitstreams of motion vectors and displacement vectors configured by applying the sign bit hiding technique.

Referring to FIG. 6, the V-DMC method transforms displacement information generated during the encoding process into video and compresses the video using an existing 2D video codec. Since the displacement information often becomes zero after transformation and quantization, there are cases where applying arithmetic coding instead of transformation into video for transmission may improve encoding efficiency. Therefore, methods of transmitting displacement information using arithmetic coding are being proposed for potential application to standards.

Among conventional displacement vector encoding methods, an arithmetic coding method based on block-based context information has been proposed, and it has been reported that this method may improve the performance of displacement vector encoding using conventional arithmetic coding. The present disclosure proposes a method to further improve the performance of the arithmetic coding method based on block-based context information. In the arithmetic coding method based on block-based context information, a sign bit for transmitting information about the sign of the value to be encoded is provided. In the proposed method, a sign bit hiding-based encoding/decoding method is proposed to enhance encoding performance by skipping the transmission of the sign bit of the first target value per encoding target group and allowing the decoder to derive the sign information. The proposed method may also be applied to the encoding of motion vector information in V-DMC that is transmitted using arithmetic coding. The embodiments include a motion vector encoding/decoding method applying the proposed sign bit hiding technique.

By applying the sign bit hiding technique to the motion vector and displacement vector encoding/decoding in V-DMC, the 1-bit sign bit encoding may be skipped per encoding target group and the decoder may be allowed to derive the corresponding information, such that the encoding performance of V-DMC may be improved.

The V-DMC referred to in the present disclosure may also be referred to as V-Mesh. The terms are used interchangeably with the same meaning.

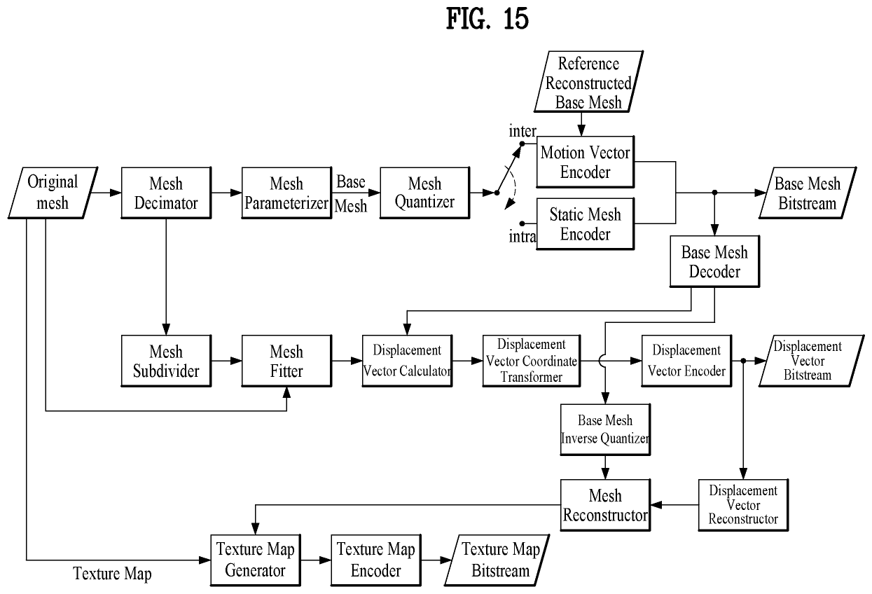

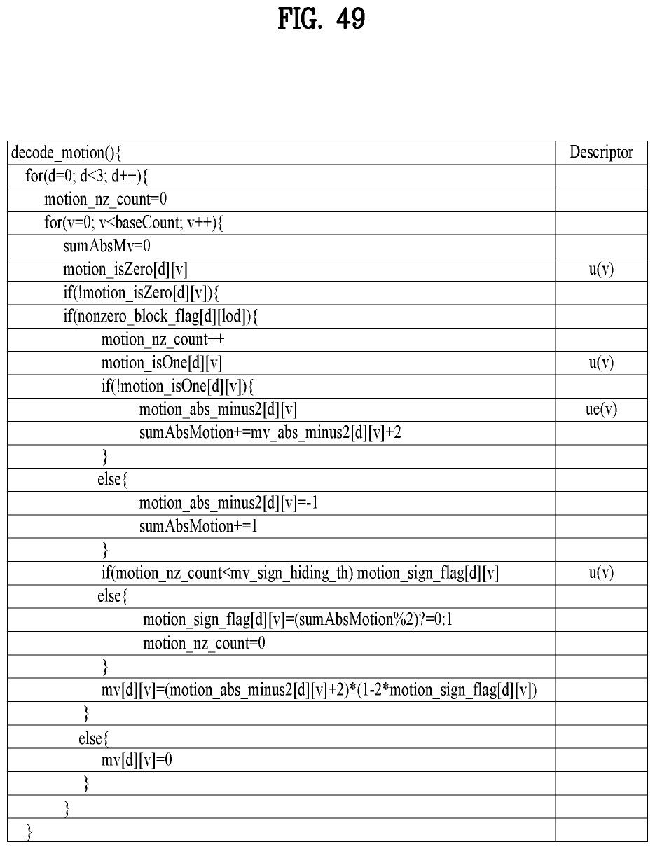

The transmission device according to teh embodiments is the transmission device 100 in FIG. 1, and the encoder according to the embodiments includes the mesh encoder 102 in FIG. 1, the pre-processor 200 and encoder 201 in FIGS. 2 and 3, the mesh subdivision in FIG. 4 and the mesh displacement calculation in FIG. 5, the intra-frame encoding in FIG. 6, the inter-frame encoding in FIG. 7, the lifting transform of displacement in FIG. 8, the packing of transform coefficients in FIG. 9, the attribute transfer in FIG. 10, the transmission device in FIG. 13, the dynamic mesh encoding in FIGS. 15 to 29, and the generation of a bitstream containing signaling information (parameters) in FIGS. 49 to 51.

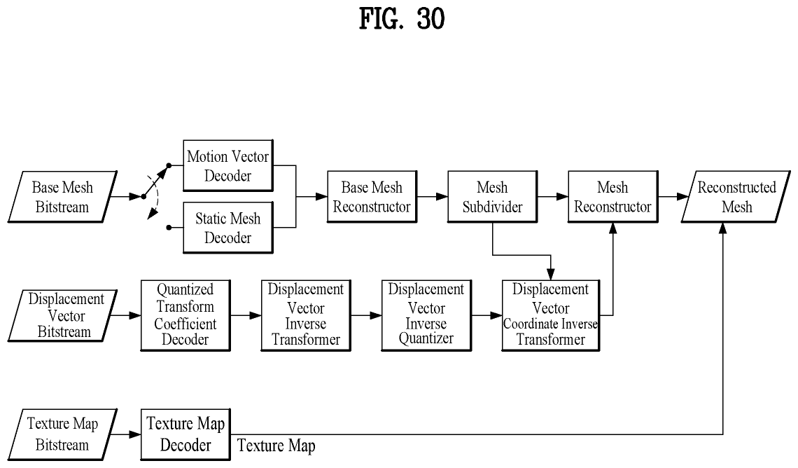

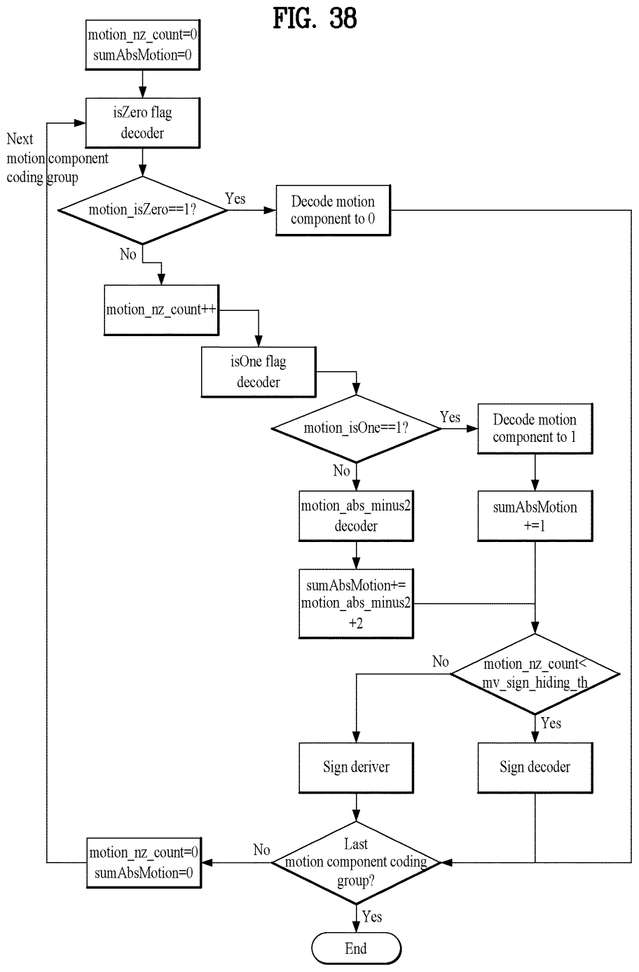

The reception device according to the embodiments is the reception advice 110 in FIG. 1, and the decoder according to the embodiments includes the mesh decoder 113 in FIG. 1, the intra-frame decoding in FIG. 11, the inter-frame decoding in FIG. 12, the the reception device in FIG. 14, the dynamic mesh decoding in FIGS. 30 to 48, and the reception of a bitstream containing signaling information (parameters) in FIGS. 49 to 51.

FIG. 15 illustrates a dynamic mesh encoder according to embodiments.

FIG. 15 specifically illustrates the configuration of the dynamic mesh encoder of the transmission device 100 in FIG. 1, the mesh encoder 102 in FIG. 1, the pre-processor 200 and encoder 201 in FIGS. 2 and 3, and the transmission device in FIG. 13. Each component in FIG. 15 corresponds to software, hardware, a processor, and/or a combination thereof.

With regard to the operation of the mesh decimator, the mesh decimator receives an original mesh as input and generates a decimated base mesh. The input mesh may be decimated based on the number of target vertices or the number of target faces. The decimation may be performed using various methods, such as triangle collapse or edge collapse.

The mesh parameterizer performs parameterization to generate texture coordinates (UV coordinates) and texture connectivity information per vertex of the input mesh.

The mesh quantizer may perform quantization by converting geometry information (x, y, z) and/or texture coordinates (u, v), normal information (nx, ny, nz), etc., from floating-point format to fixed-point format. In some embodiments, quantization may be omitted for specific components.

The motion vector encoder may receive a reference reconstructed base mesh and a current base mesh as inputs, calculate motion vectors, and encode the motion vectors. The motion vector encoder may use previously encoded/decoded motion vectors as predictors to perform connectivity-based prediction, and perform entropy encoding on the residual motion vector obtained by subtracting the predicted motion vector from the current motion vector. In some embodiments, the motion vector encoding may be performed on a per-vertex basis or a per-subgroup basis.

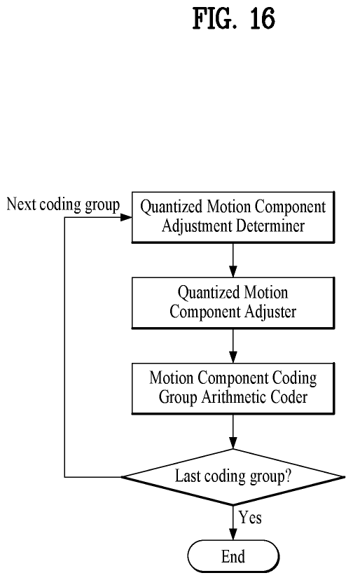

FIG. 16 illustrates a method of encoding a motion vector according to embodiments.

FIG. 16 illustrates a method of defining motion components of a motion vector per coding group in the dynamic mesh encoding in FIG. 15, and encoding the motion components within a coding group based on the coding groups.

The motion vector may be encoded for each of the motion components thereof in the x, y, and z directions. According to embodiments, 3D motion vectors may be encoded on a per-motion vector coding group basis. A motion component coding group refers to a set of m non-zero motion components or m motion components (including zero motion components) defined according to the encoding/decoding order.

A coding group in which sign bits are hidden may be a coefficient group (CG) of size N×M within a single transform unit (TU). In embodiments, the coding group may be defined as a group of m non-zero components or m components (including zero components) defined based on the order in which motion vectors or displacement vectors are encoded.

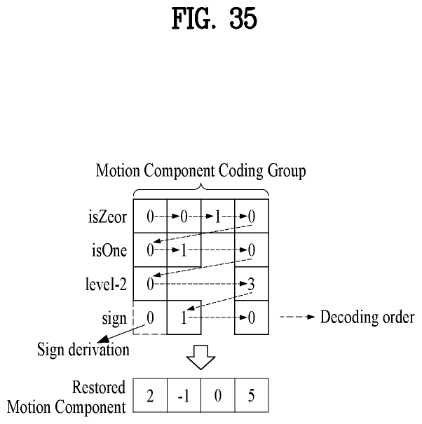

It may be possible to indicate how many non-zero/zero components have been decoded according to the encoding order. For example, the decoder may determine when m non-zero components are decoded through a counter (or count). Each time m non-zero components are decoded, the transmission of sign bits may be omitted, and the sign bits may be derived using a parity function (see FIG. 35).

In embodiments, when a motion component coding group is defined as a set of m motion components including zero motion components, a 1-bit flag may be transmitted for each motion component coding group to indicate whether a non-zero motion component is present. For each motion component coding group, encoding of the sign value of the first non-zero motion component may be skipped.

In this case, when the motion component coding group is defined as a set of m motion components including zero motion components, the encoding of sign value may be skipped only when the number of non-zero motion components in the coding group is greater than or equal to a threshold defined by an agreement between the encoder and the decoder.

A quantized motion component adjustment determiner determines whether the parity of the sum of the absolute values of the quantized motion components within the motion component coding group matches the sign value of the first non-zero motion.

$$sign ( {l}_{0} ) = parity ( abs ( {l}_{0} ) + abs ( {l}_{1} ) + … + abs ( {l}_{n - 1} ) ) ,$$

$$parity ( x ) = \{ \begin{matrix}+ , x : Even number \\ - , x : Odd number\end{matrix}$$

According to embodiments, the following parity function may be used:

$$parity ( x ) = \{ \begin{matrix}+ , x : Odd number \\ - , x : Even number\end{matrix}$$

That is, according to a preestablished configuration of the encoder and decoder, when the sum of the absolute values of motion components within a coding group is an even number, it may be defined as a positive (+) sign or a negative (−) sign.

When it is determined by the quantized motion component adjustment determiner that the parity value does not match the sign value, a quantized motion component adjuster adjusts the motion component values by calculating the motion component value that provides the best rate-distortion performance when adding adding 1 or −1 to the motion component values within the group.

A motion component coding group arithmetic coder decodes the quantized motion components in the motion component coding group.

The motion component values may be arithmetically coded based on context information for the isZero flag, . . . , isk flag, level-(k+1), and sign value. For level-(k+1), context encoding may be performed using exponential-Golomb encoding.

The context information for the values of the flag, sign, and level-(k+1) may be determined based on the type of the current mesh (inter-frame mesh or intra-frame mesh) and/or the subdivision level. Each component of the displacement vector may be encoded based on different context information using arithmetic coding. According to embodiments, some of the values the flag, sign, and level may be encoded in the bypass mode, based on fixed probability values.

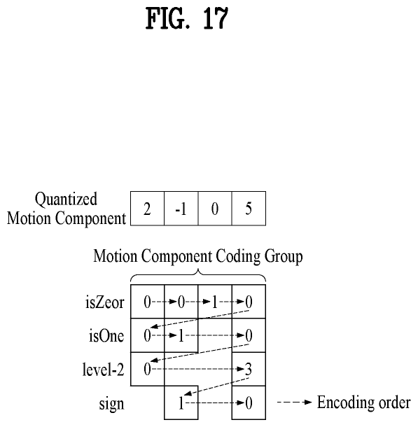

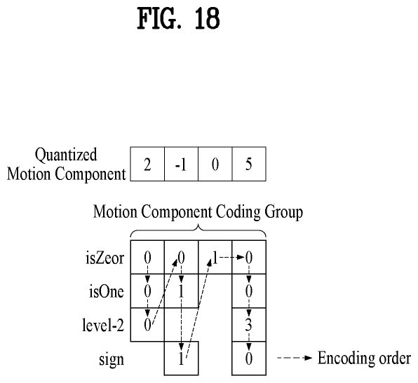

FIGS. 17 and 18 illustrate a method of encoding a coding group of motion components according to embodiments.

For example, when the size of a coding group including motion components is 4, and the quantized values of the motion components are 2, −1, 0, and 5 as described above, FIGS. 17 and 18 illustrate examples of arithmetic coding of the syntax of the coding group according to the encoding order.

In this case, encoding of the sign of the first non-zero motion component in the motion component coding group may be skipped, and the sign may be implicitly derived identically during encoding/decoding based on the parity of the sum of the absolute values of the motion components in the group.

The coding group has the following syntax: the flag (isZero) indicating whether the first motion component 2 is zero is 0, the flag (isOne) indicating whether the first motion component 2 is 1 is 0, and the value obtained by subtracting 2 from the absolute value of 2 is 0. The sum of the absolute values of the motion components in the coding group is 8, which is an even number. When the parity function is defined such that when x is even, the function returns a positive (+) sign, the first non-zero motion component is 2 and its sign is positive. Thus, the sign of 2 in the coding group is omitted during encoding. Since the second motion component is −1, the coding group additionally includes a flag equal to 0 indicating whether the component −1 is zero, a flag equal to 1 indicating whether it is 1, and 1, which is a value indicating the sign of −1. Similarly, since the third motion component is 0, the coding group further includes a flag 1 indicating whether 0 is zero. Since the fourth motion component is 5, the coding group further includes a flag 0 indicating whether 5 is zero, a flag 0 indicating whether 5 is 1, a value 3 obtained by subtracting 2 from the absolute value of 5, and a value 0 indicating the sign of 5. According to the encoding order shown in FIG. 17, the motion components in the coding group are arithmetically encoded in order of 0, 0, 1, 0, 0, 1, 0, 0, 3, 1, and 0.

As shown in FIG. 18, the motion components in the coding group are arithmetically encoded in order of 0, 0, 0, 0, 1, 1, 1, 0, 0, 3, and 0 according to the encoding order in FIG. 18, instead of the encoding order in FIG. 17.

The embodiments may define a coding group as a unit that includes multiple motion components and enable efficient arithmetic coding by omitting the sign of the first non-zero motion component in each coding group every time arithmetic coding is performed on each coding group.

The static mesh encoder performs encodes connectivity information, vertex geometry information, vertex texture coordinates, normal information, and the like related to the base mesh.

The mesh subdivider may subdivide the base mesh to generate additional vertices. In this case, depending on the subdivision method, additional vertices may be generated by implicitly deriving geometry connectivity information, texture coordinate connectivity information, and texture coordinates.

The mesh subdivider may perform subdivision using a method such as mid-edge, Loop, or Catmull-Clark according to embodiments.

The mesh subdivision may be performed n times based on user parameters or an agreement between the encoder and the decoder. According to embodiments, when a vertex of the base mesh is defined as R₀, a new vertex generated by performing subdivision once is defined as R₁, . . . , and a new vertex generated by performing subdivision n times is defined as Rₙ, the Level of Detail (LoDₙ) may be defined as follows: LoDₙ=R₀∪R₁∪, . . . , ∪Rₙ.

A mesh fitter adjusts the vertex positions such that the subdivided mesh becomes similar to the original mesh.

According to embodiments, the mesh decimator, mesh parameterizer, mesh subdivider, and mesh fitter may be omitted. When the corresponding operations are skipped, the original mesh may be applied as input to the mesh quantizer.

In this case, coordinate information related to the original mesh may be input to the displacement vector calculator. In some embodiments, the displacement vector encoding process (including the displacement vector calculator, displacement vector coordinate transformer, and displacement vector encoder) may be omitted.

The displacement vector calculator calculates displacement vectors between the fitted subdivided mesh and the reconstructed current base mesh.

Using the displacement vector calculator, displacement vectors corresponding to the number of vertices of the subdivided mesh may be calculated.

The displacement vector coordinate transformer may transform the vertex displacement vectors calculated in (x, y, z) space into coordinates (normal, tangential, bi-tangential) based on the normal vector of each vertex.

According to embodiments, only the normal component among the coordinates (normal, tangential, bi-tangential) may be encoded. When coordinate transformation is applied according to an agreement between the encoder and the decoder, only the normal component may always be encoded. Alternatively, the encoder may determine the transformation and signal a 1-bit flag (onlyNormFlag).

In this case, the normal vector may be calculated for each subdivided vertex based on the geometry information and connectivity information related to surrounding vertices.

Whether to apply the displacement vector coordinate transformation may be determined by agreement between the encoder and the decoder. Alternatively, a flag indicating whether to apply coordinate transformation (applyLocalCoord) may be transmitted per sequence, GOF (group of frames), frame, or submesh to determine whether to apply the coordinate transformation.

The displacement vector encoder may encode displacement vectors using a 2D video encoder such as H.264, HEVC, or VVC, or using a zero run-length encoder or arithmetic coder.

For the displacement vector encoding method, a specific encoding method may be determined by an agreement between the encoder and the decoder, or an encoding method determined by the encoder may be signaled as a flag or index (displacement_method).

There may be various displacement vector encoding methods. According to embodiments, one method among {video codec-based encoding, zero run-length encoding}, {video codec-based encoding, zero run-length encoding}, {video codec-based encoding, arithmetic coding}, or {video codec-based encoding, zero run-length encoding, arithmetic coding} may be determined through the displacement_method flag or index.

According to embodiments, the displacement vector encoding method may be determined according to a profile defined in the encoder and decoder. An index (profile_toolset_idc) indicating the profile information may be signaled, such that the decoder may determine the displacement vector decoding method according to the profile_toolset_idc.

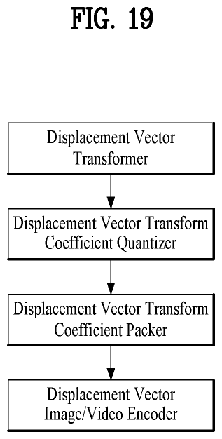

FIG. 19 illustrates a method of encoding a displacement vector using video encoding according to embodiments. FIG. 19 illustrates a method of encoding a displacement vector by a 2D video encoder.

The displacement vector transformer transforms displacement vectors into displacement coefficients.

The displacement vector transform coefficient quantizer quantizes the displacement coefficients.

The displacement vector coefficient packer packs the transform coefficients into an image.

The displacement vector image/video encoder encodes the image or video including the transformcoefficients.

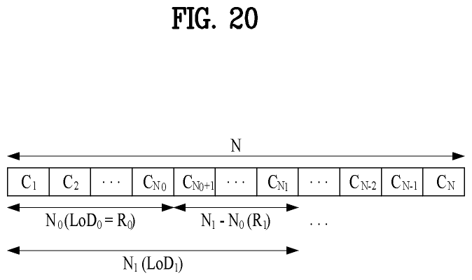

FIG. 20 illustrates transform coefficients of a displacement vector according to embodiments.

FIG. 20 illustrates the operation of the displacement vector coefficient packer in FIG. 19. The N displacement vector transform coefficients from the displacement vector transformer are packed into a W×H sized image.

Packing may organize transform coefficients OF a 1D vector or scalar into blocks of size bx×by, each containing bx×by tranform coefficients. M blocks determined according to the number N of displacement vector tranform coefficients may be packed into the image in z-scan or zig-zag scan order.

The M displacement vector transform coefficient blocks may be packed into an image of size (bx*L)×(by*M) according to an order defined by the encoder/decoder.

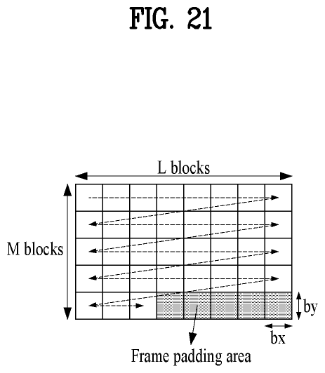

FIG. 21 illustrates transform coefficient blocks of a displacement vector according to embodiments.

FIG. 21 illustrates the operation of padding the remaining area in the image after the image packing of FIG. 20 to adjust the size.

In this case, packing is sequentially performed from the R₀ displacement vector transform coefficient block according to scanning order. When the size of coefficients is smaller than L×M, padding may be performed such that the size of the displacement vector image becomes (bx*L)×(by*M).

According to embodiments, L and M may be determined based on the number N of displacement vector transform coefficients. Alternatively, L (or M) may be defined by an agreement between the encoder and the decoder, and then M (or L) may be derived based on the number N of displacement coefficients.

When L is defined by an agreement between the encoder and the decoder, M may be derived using the following equation:

$$blockNum = round ( ( N + bx * by - 1 ) / ( bx * by )$$

$$M = round ( ( blockNum + L - 1 ) / L )$$

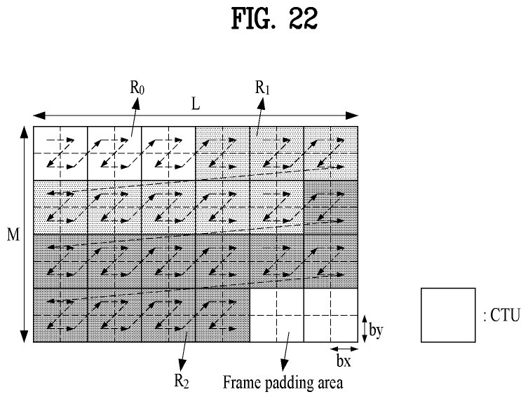

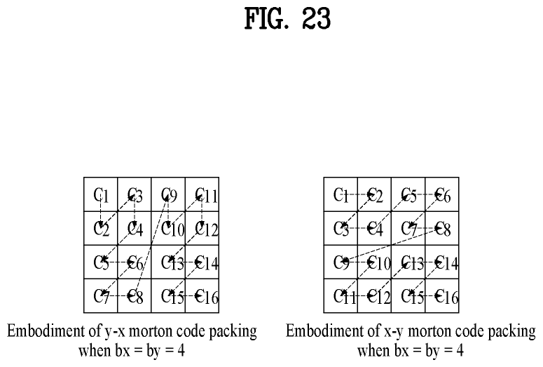

FIGS. 22 and 23 illustrate packing of transform coefficient blocks of a displacement vector according to embodiments.

Referring to FIG. 22, according to embodiments, packing of transform coefficient blocks (of size bx×by) may be performed according to the CTU size of the 2D video encoder that encodes each subdivision level R.

Here, the padding may be performed per subdivision level to fit the CTU size.

The padding may be performed based on the median value of the image, the value of the last transform coefficient, or the like.

In one transform coefficient block, bx×by transform coefficients may be packed according to a z-scan order, zig-zag scan order, or 2D Morton code order.

Referring to FIG. 23, the transform coefficients may be packed according to a 2D Morton code order.

The displacement vector image/video encoder encodes the 2D displacement vector image/video, which has been packed by the displacement vector transform coefficient packer, using a 2D video encoder.

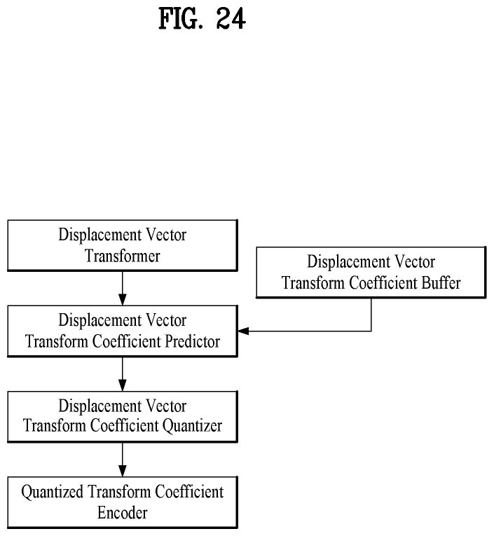

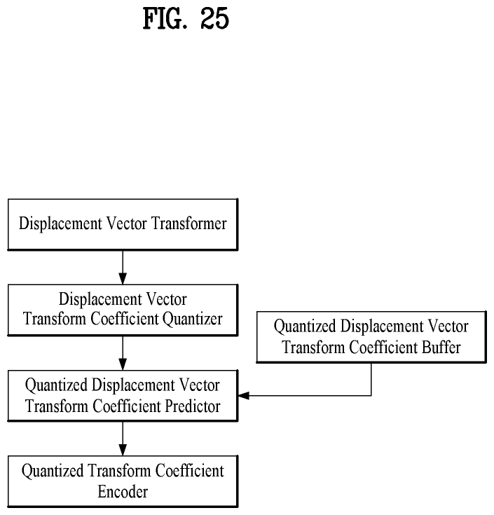

FIGS. 24 and 25 illustrate methods of encoding transform coefficients of a displacement vector according to embodiments.

When displacement vectors are encoded using an arithmetic coder, the displacement vector encoding may be performed according to the method illustrated in FIG. 24 or FIG. 25.

According to embodiments, when the current mesh is a mesh on which inter-frame prediction is performed, prediction may be performed using the displacement vector transform coefficients of the reconstructed reference frame (FIG. 24) or the quantized displacement vector transform coefficients (FIG. 25) as predictors, as follows.

```
for(size_t v=0; v<N; v+ +){
  for(size_t d=0; d<dim; d+ +){
    dispCoeff[v][d] = curdispCoeff[v][d] − refDispCoeff[v][d]
  }
}
```

Specifically, the displacement vector transformer operates as follows.

Displacement vectors in the (x, y, z) or (n, t, bt) coordinate system may be transformed by the displacement vector transformer.

According to embodiments, when coordinate transformation to the (n, t, bt) coordinate system is performed, a 1D scalar displacement vector of the normal component (n) may be input to the displacement vector transformer, and then transformation, quantization, and encoding may be performed on the displacement value of the normal component.

In embodiments, for the transformation, lifting transform or wavelet transform may be performed.

When lifting transform is performed, prediction is performed for vertex Rₖ at the k-th subdivision level, the displacement vector at the k-th subdivision level may be predicted using the subdivided vertex displacement vector of the predictor Rₜ (where t<k or t<=k).

According to embodiments, when performing displacement vector prediction, prediction may be performed based on an average or distance-based weighted average of the nearest n points among vertices at lower subdivision levels than the current vertex.

According to embodiments, prediction may be performed based on the displacement vectors of n vertices used to generate the current vertex during the mesh subdivision.

When lifting transform is performed, displacement vectors of vertices used in the prediction may be updated using the residual signal generated by the prediction.

The displacement vector transform coefficient quantizer performs the following operation.

It quantizes the transform coefficients generated by the displacement vector transformer.

According to embodiments, quantization may be performed on transform coefficients with different quantization parameters for each axis. The quantization or scaling parameters may be derived according to an agreement between the encoder and the decoder to determine the quantization rate for each LoD

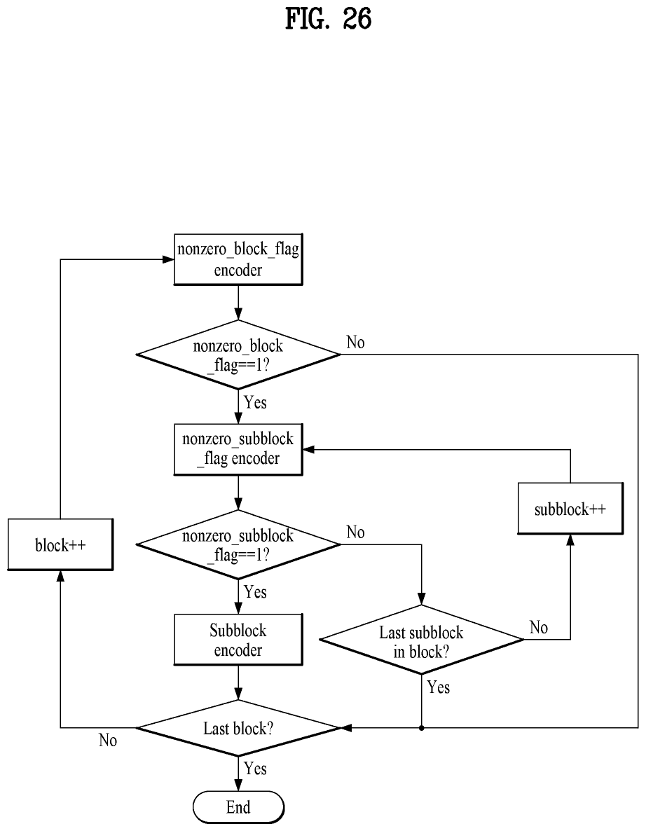

FIG. 26 illustrates a method of encoding transform coefficients according to embodiments.

FIG. 26 illustrates a method of encoding transform coefficients of displacement vectors. The transform coefficients, which are quantized residual values, are encoded as illustrated in FIG. 26.

When encoding transform coefficients of displacement vectors, nonzero_block_flag/nonzero_subblock_flag, which indicates the presence or absence of nonzero quantized transform coefficients in blocks and subblocks, may be encoded.

The block refers to a set of quantized displacement vector transform coefficients that is larger than a subblock, and nonzero_subblock_flag may be additionally encoded only for blocks with nonzero_block_flag equal to 1.

According to embodiments, for nonzero_block_flag, a 1-bit flag may be encoded for each subdivision level of the displacement vector to signal whether any nonzero level values are present within that subdivision level.

According to embodiments, the position of the first nonzero quantized transform coefficient (last_nonzero_pos) among the quantized transform coefficients may be encoded using exponential-Golomb coding based on separate context information.

For the nonzero_block_flag/nonzero_subblock_flag, context information may be determined based on the current mesh type (inter-frame or intra-frame mesh) and/or subdivision level. Different context information may be used for each component of the displacement vector to perform arithmetic coding.

According to embodiments, nonzero_block_flag/nonzero_subblock_flag may be encoded in the bypass mode, in which arithmetic coding is performed based on fixed probability values.

According to embodiments, a flag for a specific subdivision level may be omitted and implicitly derived according to an agreement between the encoder and the decoder.

According to embodiments, only one of nonzero_block_flag or nonzero_subblock_flag may be encoded.

According to embodiments, the displacement vector transform coefficient encoder may operate separately for each dimension of the displacement vector (to transmit block/subblock flags for each component). When the displacement vector is transformed into (n, t, b) to be encoded, the component n and the components t and b may be encoded.

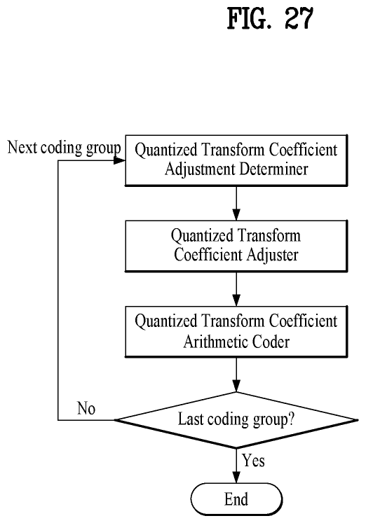

FIG. 27 illustrates a method of encoding a coding group of transform coefficients according to embodiments.

FIG. 27 illustrates the operation of the subblock encoder of FIG. 26 in detail.

The subblock encoder may encode quantized transform coefficients on a transform coefficient coding group (coeff_coding_group) basis.

The transform coefficient coding group may be identical to or independent from a subblock.

According to embodiments, when the transform coefficient coding group is independent from the subblock, k non-zero transform coefficients may be grouped as one coding group according to the encoding/decoding order of the displacement vector.

According to embodiments, the size of the coding group may be variably determined by an agreement between the encoder and the decoder based on the subdivision level of the displacement vector, and/or QP value of the displacement vector, and/or mesh type (inter-frame or intra-frame mesh).

Encoding of the sign of the first non-zero transform coefficient in the coding group may be skipped, and the sign may be identically derived by the encoder/decoder based on the parity bit of the sum of the absolute values of the quantized transform coefficients in the group.

$$sign ( {l}_{0} ) = parity ( abs ( {l}_{0} ) + abs ( {l}_{1} ) + … + abs ( {l}_{n - 1} ) ) ,$$

$$parity ( x ) = \{ \begin{matrix}+ , x : Even number \\ - , x : Odd number\end{matrix}$$

According to embodiments, the following parity function may be used:

$$parity ( x ) = \{ \begin{matrix}+ , x : Odd number \\ - , x : Even number\end{matrix}$$

When the value of the parity is an even number, the sign value may be derived as positive (or negative). When the value of the parity is an odd number, the sign value may be derived as negative (or positive).

According to an embodiment, when the transform coefficient coding group is the same as a subblock or when k transform coefficients (including zero transform coefficients) are configured as one coding group according to the encoding/decoding order, the sign may be omitted only when the number of non-zero transform coefficients in the coding group is greater than a threshold defined by the encoder/decoder.

The quantized transform coefficient adjustment determiner determines whether the parity of the sum of the absolute values of the quantized transform coefficients in the transform coefficient coding group matches the sign of the first non-zero level.

When it is determined by the transform coefficient adjustment determiner that the parity value does not match the sign value, a quantized transform coefficient adjuster adjusts the coefficient values by calculating the coefficient value that provides the best rate-distortion performance when adding or adding 1 or −1 to the coefficient values within the group.

A quantized transform coefficient arithmetic coder performs arithmetic coding on the quantized transform coefficients on a quantized transform coefficient coding group basis for subblocks with nonzero_subblock_flag=1.

The transform coefficient values may be arithmetically coded based on context information for the isK flag (K=0, 1, . . . ), level-(K+1) and sign value.

For Level-(K+1), context encoding may be performed using exponential-Golomb encoding.

The context information for the values of the flag, sign, and level-(K+1) may be determined based on the type of the current mesh (inter-frame mesh or intra-frame mesh) and/or the subdivision level. Each component of the displacement vector may be encoded based on different context information using arithmetic coding.

According to embodiments, some of the values the flag, sign, and level may be encoded in in the bypass mode, based on fixed probability values.

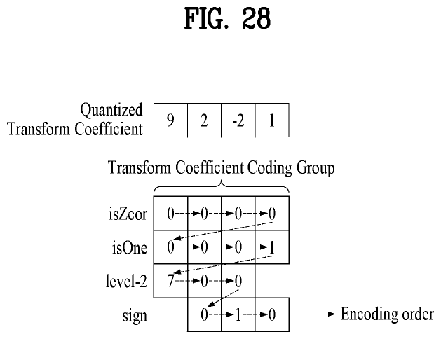

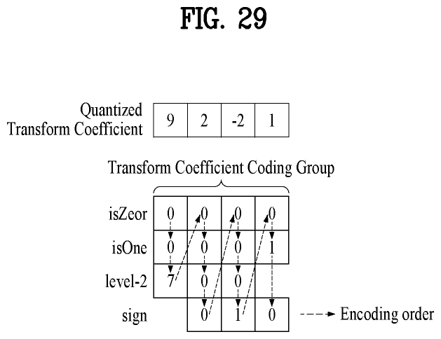

FIGS. 28 and 29 illustrate a coding group of transform coefficients according to embodiments.

FIGS. 28 and 29 illustrate embodiments in which the values of quantized transform coefficients of 9, 2, −2, and 1 are encoded when the size of the transform coefficient coding group is 4. Arithmetic coding may be performed for each syntax in the orders shown in FIGS. 28 and 29, respectively.

In this case, encoding of the sign of the first non-zero transform coefficient in the coding group may be skipped, and the sign may be implicitly derived identically during encoding/decoding based on the parity of the sum of the absolute values of the transform coefficients in the group.

In FIGS. 28 and 29, when the quantized transform coefficients are 9, 2, −2, and 1, the method/device may define and generate coding groups according to the coefficients. For example, for the first transform coefficient equal to 9, a value of 0, which indicates whether the coefficient is zero, a value of 0, which indicates whether the coefficient is 1, and a value of 7, which is obtained by subtracting 2 from the absolute value of the transform coefficient component, may be defined. When the parity function defines the case of even number as +, the sum of the absolute values of 9, 2, −2, and 1 is even, and thus the parity value+equals the sign+of 9. Therefore, the sign encoding for 9 is skipped. Similarly, the coding groups for 2, −2, and 1 are defined and encoded in a horizontal direction (FIG. 28) or vertical direction (FIG. 29).

The base mesh decoder reconstructs the base mesh based on the encoding type of the current mesh (inter-frame encoding or intra-frame encoding).

When inter-frame encoding is performed, the current base match may be generated by adding the reconstructed motion vectors to the reconstructed base mesh.

In the case where the motion vectors are not quantized, the motion vector reconstruction process may be omitted and the motion vectors calculated by the motion vector encoder may be used to reconstruct the current base mesh.

When intra-frame encoding is performed, inverse quantization may be performed on the base mesh quantized by the mesh quantizer to reconstruct the current base mesh.

The base mesh inverse quantizer performs inverse quantization on input information such as reconstructed geometry information (x, y, z), and/or texture coordinates (u, v), and/or normal information (nx, ny, nz).

In some embodiments, inverse quantization of specific components may be skipped.

The displacement vector reconstructor decodes the displacement vector by performing the inverse process of displacement vector encoding. This process operates in the same manner as in the displacement vector reconstructor of the dynamic mesh decoder, which is described in detail later in the description of the decoder.

The mesh reconstructor performs subdivision on the reconstructed base mesh, which is obtained by inverse quantization by the base mesh inverse quantizer, to generate subdivided vertex position information, texture coordinates, and connectivity information.

Reconstructed displacement vectors are added to the subdivided vertex position information to generate reconstructed vertex position information.

The texture map generator generates the texture map of the reconstructed mesh based on the relationship among the texture coordinates and connectivity of the reconstructed mesh, the original mesh, and the texture map of the original mesh.

The texture map encoder configures a texture map video by stacking the texture maps generated by the text map generator in order of frames of the mesh and encodes the video using a 2D video encoder.

According to embodiments, when the color space of the texture map is RGB444, it may be converted to YUV420, YUV444, or other color spaces before encoding.

FIG. 30 illustrates a dynamic mesh decoder according to embodiments.

FIG. 30 illustrates a reception device according to embodiments, which corresponds to the reception device 110 in FIG. 1. The decoder includes or performs the mesh decoder 113 in FIG. 1, the intra-frame decoding in FIG. 11, the inter-frame decoding in FIG. 12, the reception device in FIG. 14, the dynamic mesh decoding in FIGS. 30 to 48, and the reception of a bitstream containing signaling information (parameters) in FIGS. 49 to 51.

In FIG. 30, the inverse operation of the dynamic mesh encoder in FIG. 15 is performed.

### Static Mesh Decoder

The static mesh decoder may reconstruct connectivity information, vertex geometry information, vertex texture coordinates, and normal information related to the base mesh.

### Base Mesh Reconstructor

When the current base mesh has been encoded based on a reference mesh, motion vectors may be added to the reference base mesh and the result of the addition may be inversely quantized to reconstruct the current base mesh.

When the current base mesh has been decoded by the static mesh encoder, inverse quantization is performed to generate the reconstructed base mesh.

In some embodiments, inverse quantization may be skipped.

### Displacement Vector Inverse Transformer:

Performs inverse transform of the transformation performed by the encoder.

Transform such as lifting transform or wavelet transform may be performed.

When lifting transform is performed, prediction is performed for vertex R_k at the k-th subdivision level, the displacement vector at the k-th subdivision level may be predicted using the subdivided vertex displacement vector of the predictor R_t (where t<k or t<=k).

According to embodiments, when performing displacement vector prediction, prediction may be performed based on an average or distance-based weighted average of the nearest n points among vertices at lower subdivision levels than the current vertex.

According to embodiments, prediction may be performed based on the displacement vectors of n vertices used to generate the current vertex during the mesh subdivision.

When lifting inverse transform is performed, displacement vectors of vertices used in the prediction by the encoder may be updated using the parsed residual signal.

The displacement vector inverse quantizer performs inverse quantization on the displacement vectors.

According to embodiments, quantization may be performed on transform coefficients with different quantization parameters for each axis. The quantization or scaling parameters may be derived according to an agreement between the encoder and the decoder to determine the quantization rate for each LoD.

When the flag indicating whether to apply coordinate transformation (applyLocalCoord) parsed per sequence, GOF, frame, or submesh is equal to 1, the displacement vector inverse coordinate transformer may inversely transform the inversely quantized reconstructed displacement vector to the (x, y, z) coordinates.

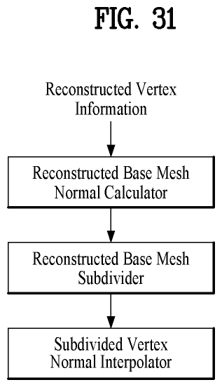

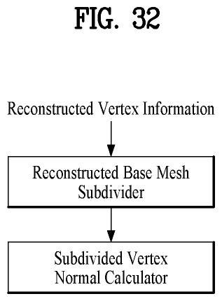

FIGS. 31 and 32 illustrate a method of inversely transforming the coordinate system of a displacement vector according to embodiments.

In the inverse coordinate transform operation for the displacement vector, as illustrated in FIG. 31, a normal vector may be calculated per vertex based on the reconstructed vertex position information related to the reconstructed base mesh, and additional vertices may be generated by subdivision. Then, normal values may be assigned to the new generated vertices by interpolating the vertex normal vectors of the reconstructed base mesh calculated for the generated vertices.

In this case, the interpolation may be performed by obtaining the average or distance-based weighted sum of normal information related to the base mesh used in the subdivision.

Also, as shown in FIG. 32, according to an embodiment, subdivision may be performed on the reconstructed base mesh, and then normal vectors may be calculated for both the vertices generated by the subdivider and the vertices of the base mesh.

Based on the calculated normal vectors per vertex, tangential and bi-tangential vectors perpendicular to the normal vectors may be calculated, and the inverse coordinate transform of the displacement vector may be performed using the following equation.

$$\vec{{disp}_{xyz}} = {disp}_{n} [ 0 ] * \vec{n} + {disp}_{n} [ 1 ] * \vec{t} + {disp}_{n} [ 2 ] * \vec{b}$$

According to an embodiment, the inverse coordinate transform may always be performed without transmitting a flag.

### Mesh Subdivider

The mesh subdivider may subdivide the base mesh to generate additional vertices. In this case, depending on the subdivision method, additional vertices may be generated by implicitly deriving geometry connectivity information, texture coordinate connectivity information, and texture coordinates.

The mesh subdivider may perform subdivision using a method such as mid-edge, Loop, or Catmull-Clark according to embodiments. The mesh subdivision may be performed n times based on user parameters or an agreement between the encoder and the decoder. According to embodiments, when a vertex of the base mesh is defined as R_0, a new vertex generated by performing subdivision once is defined as R_1, . . . , and a new vertex generated by performing subdivision n times is defined as R_n, LoD_n may be defined as follows: LoDₙ=R₀∪R₁∪, . . . , ∪Rₙ

The mesh reconstructor adds the reconstructed displacement vectors to the vertices generated through the subdivision by the mesh subdivider to calculate the vertex position information related to the reconstructed mesh.

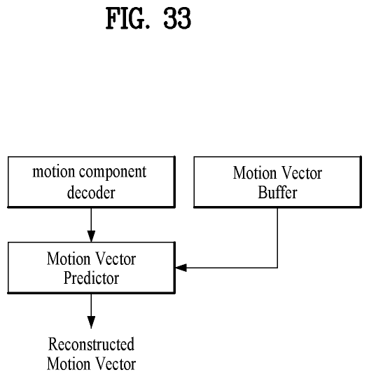

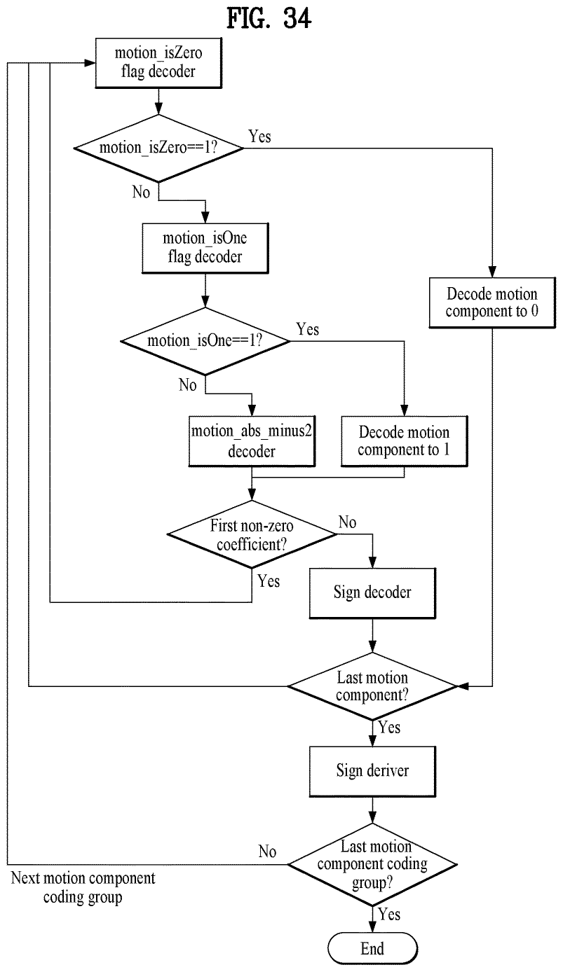

FIGS. 33 and 34 illustrate methods for decoding motion vectors according to embodiments.

The motion vector decoder may perform motion vector decoding when the current mesh undergoes inter-frame prediction.

Through the motion vector bitstream, residual motion vectors for each vertex or subblock may be decoded, and prediction based on connectivity information may be performed using previously decoded motion vectors as predictors. The result of the prediction may be added to the residual motion vectors to decode the motion vectors.

An embodiment of the motion component decoder is illustrated in FIG. 34.

According to an embodiment, the isK (0, 1, . . . ) flag may be parsed to determine whether a motion component equals K.

The operations in FIG. 34 are described below.

A motion component coding group may refer to a set of m non-zero motion components or m motion components (including zero motion components) defined according to the encoding/decoding order.

According to an embodiment, the size of the coding group may be variably determined by an agreement between the encoder and the decoder based on the QP value of the motion components.

For the first decoded non-zero motion component in the motion component coding group, sign decoding may be skipped, and the sign may be derived by checking the parity bit of the sum of the absolute values of the decoded motion components in the coding group by a sign deriver.

An embodiment of sign derivation performed when n non-zero motion components in the motion component coding group are decoded may be represented by the following equation.

$$sign ( {l}_{0} ) = parity ( abs ( {l}_{0} ) + abs ( {l}_{1} ) + … + abs ( {l}_{n - 1} ) ) ,$$

$$parity ( x ) = \{ \begin{matrix}+ , x : Even number \\ - , x : Odd number\end{matrix}$$

According to embodiments, the following parity function may be used:

$$parity ( x ) = \{ \begin{matrix}+ , x : Odd number \\ - , x : Even number\end{matrix}$$

According to an embodiment, motion components may be decoded in descending order of indices of the vertices.

FIGS. 35, 36, 37, and 38 illustrate a method of reconstructing a coding group of motion components according to embodiments.

An embodiment of decoding a transform coefficient coding group when a subblock is decoded according to the embodiment of FIG. 34 is illustrated in FIG. 35.

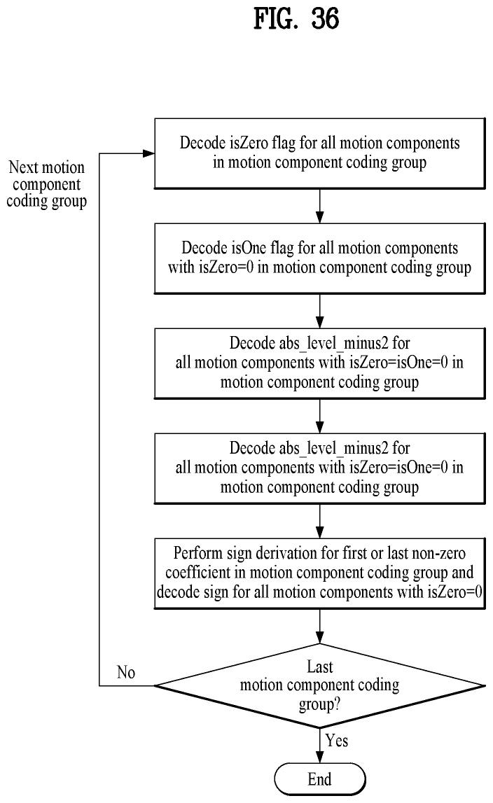

According to an embodiment, transform coefficients for the subblock may be decoded as in the embodiment illustrated in FIG. 36.

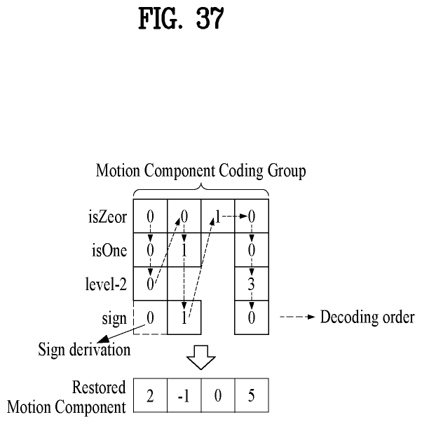

An embodiment of decoding a transform coefficient coding group when a subblock is decoded according the embodiment of FIG. 36 is illustrated in FIG. 37.

When the motion component coding group is defined as a set of m non-zero motion components defined according to the decoding order, motion component decoding may be performed according to the following embodiment.

According to the decoding order of motion components, the number of non-zero motion components may be counted by motion_nz_count. Based on comparison between the counted value and mv_sign_hiding_th(=m), a threshold defined according to an agreement between the encoder and the decoder or parsed per frame, slice, or patch, sign derivation or sign decoding may be performed.

When motion_nz_count is less than mv_sign_hiding_th, sign decoding may be performed to decode the sign value (mv_sign_flag) of the current motion component. When motion_nz_count is equal to mv_sign_hiding_th, the sign deriver may derive the sign of the current motion component based on sumAbsMotion.

The sign deriver may operate according to the following equation: motion_sign_flag=(sumAbsMotion % 2)?0:1 or motion_sign_flag=(sumAbsMotion % 2)? 1:0.

Just as the encoding of the first component in the coding group is skipped in the above-described encoding operation, decoding of the first component may be skipped in the decoding operation. When the sum of the absolute values of motion components in the coding group is an even number, the sign may be 0. When the sum is an odd number, the sign may be 1. Alternatively, the sign may be set in the opposite way. The sign may be 1 when the sum is an even number, and may be 0 when the sum is an odd number.

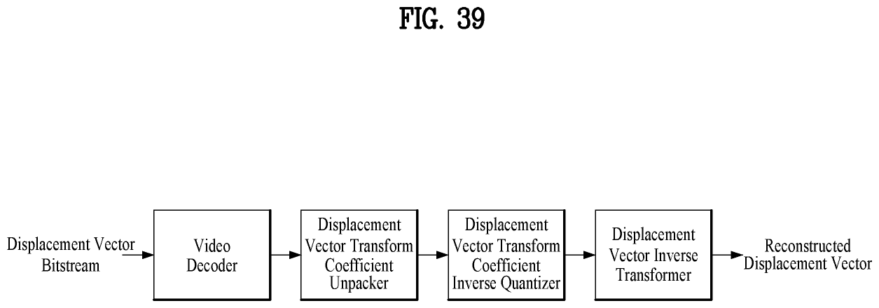

FIG. 39 illustrates a displacement vector decoder according to embodiments.

When the displacement vector is decoded by a 2D video encoder, the displacement vector decoder may reconstruct the displacement vector through the process illustrated in FIG. 39.

The displacement vector bitstream is input to the video decoder, which decodes the displacement vector transform coefficient image/video.

For the displacement vector transform coefficient video reconstructed by the video decoder, displacement vector transform coefficients corresponding to each vertex of the reconstructed mesh may be allocated for each frame by a displacement vector transform coefficient unpacker.

The displacement vector transform coefficient unpacker may perform unpacking based on the reconstructed displacement vector transform coefficient image corresponding to the current mesh frame according to the scanning order defined by an agreement between the encoder and the decoder or the scanning order parsed per higher-level unit (sequence, frame, etc.).

For the transform coefficient blocks packed in a specific scanning order in units of bx×by and the displacement vector transform coefficients packed in a single block in a specific order, the displacement vector transform coefficients of the k-th vertex may be derived according to an agreement between the encoder/the decoder or based on the parsed block sizes bx and by, and L, M, and the scanning order.

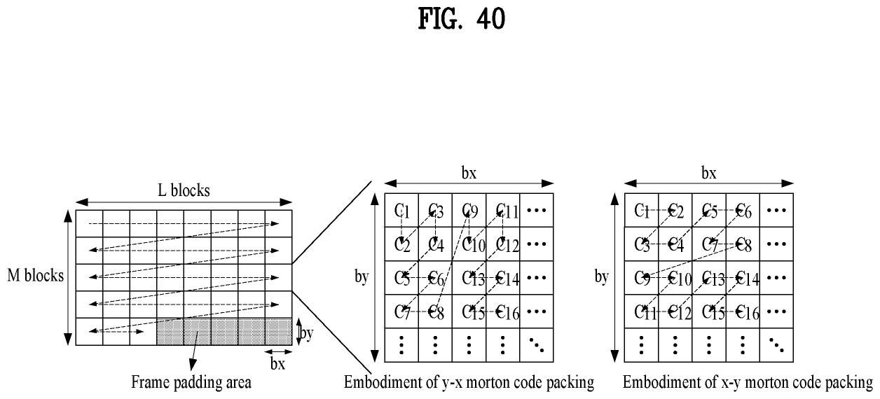

FIG. 40 illustrates a method of inversely packing transform coefficients of a displacement vector according to embodiments.

The displacement vector transform coefficients allocated per vertex by the displacement vector transform coefficient unpacker are inversely quantized by the displacement vector transform coefficient inverse quantizer.

According to embodiments, quantization parameters (QP) for each axis may be transmitted per sequence or frame. When only the displacement vector of the normal component is encoded/decoded (onlyNormFlag=1), only the QP for the normal component may be parsed to determine the quantization rate.

According to embodiments, quantization may be performed on transform coefficients with different quantization parameters for each axis. The quantization or scaling parameters may be derived according to an agreement between the encoder and the decoder to determine the quantization rate for each LoD.

The displacement vector inverse transformer calculates the reconstructed displacement vector by performing the inverse transform on the inversely quantized displacement vector transform coefficients.

In embodiments, for the transformation, lifting transform or wavelet transform may be performed.

When lifting transform is performed, prediction is performed for vertex Rₖ at the k-th subdivision level, the displacement vector at the k-th subdivision level may be predicted using the subdivided vertex displacement vector of the predictor Rₜ (where t<k or t<=k).

According to embodiments, when performing displacement vector prediction, prediction may be performed based on an average or distance-based weighted average of the nearest n points among vertices at lower subdivision levels than the current vertex.

According to embodiments, prediction may be performed based on the displacement vectors of n vertices used to generate the current vertex during the mesh subdivision.

When lifting inverse transform is performed, displacement vectors of vertices used in the prediction by the encoder may be updated using the parsed residual signal.

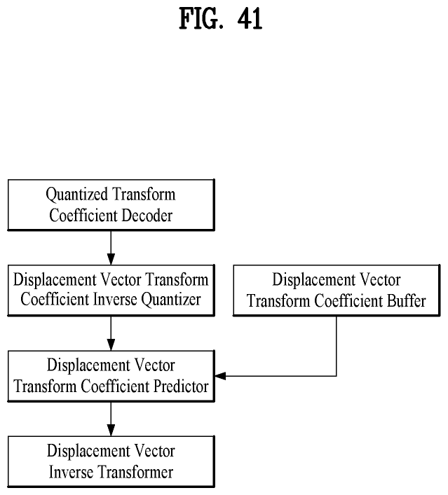

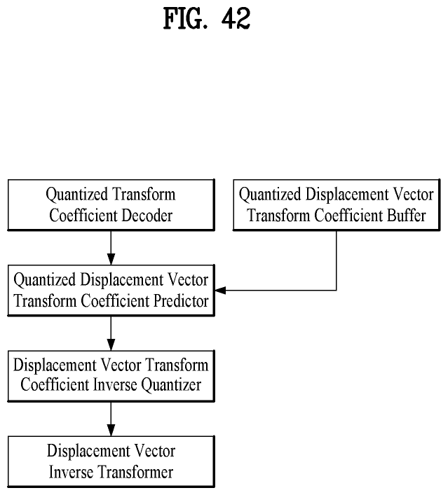

FIGS. 41 and 42 illustrate a method of decoding a displacement vector according to embodiments.

When displacement vectors are encoded using the arithmetic coder, displacement vector decoding may be performed according to FIG. 41 or 42.

When the current mesh frame is of a type of inter-prediction frame and has a 1-to-1 mapping relationship with the reference mesh, prediction of the current displacement vector transform coefficient (FIG. 41) or quantized transform coefficient (FIG. 42) may be performed based on the reconstructed displacement vector transform coefficients or quantized transform coefficients of the reference mesh.

The reconstructed displacement vector transform coefficient levels of the reference mesh may be stored and used for prediction according to the mesh reference structure.

When the current mesh frame is of a type of intra-prediction frame or does not have a 1-to-1 mapping relationship with the reference mesh, the displacement vector transform coefficient predictor may be omitted.

The predicted displacement vector transform coefficient (refDispLevel) may be added to the restored residual displacement vector transform coefficient (dispLevel) and the current displacement vector transform coefficient (curdispLevel) may be calculated as follows.

```
for(size_t v=0; v<N; v+ +){
  for(size_t d=0; d<dim;d + +){
    curdispCoeff[v][d] = dispCoeff[v][d]+refDispCoeff[v][d]
  }
}
```

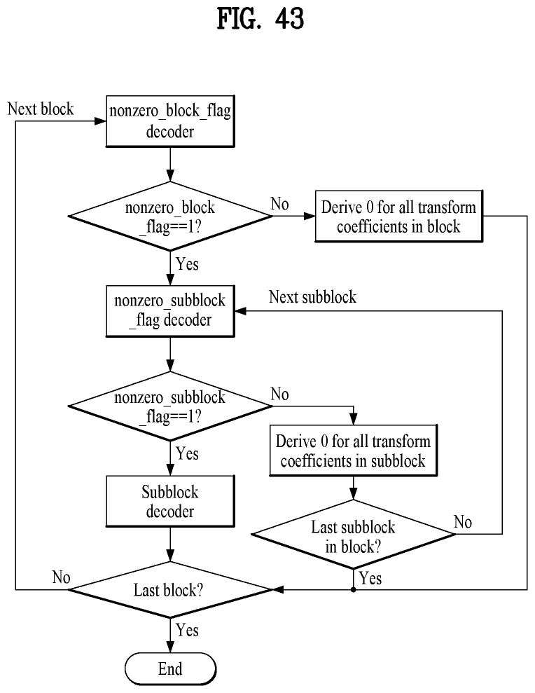

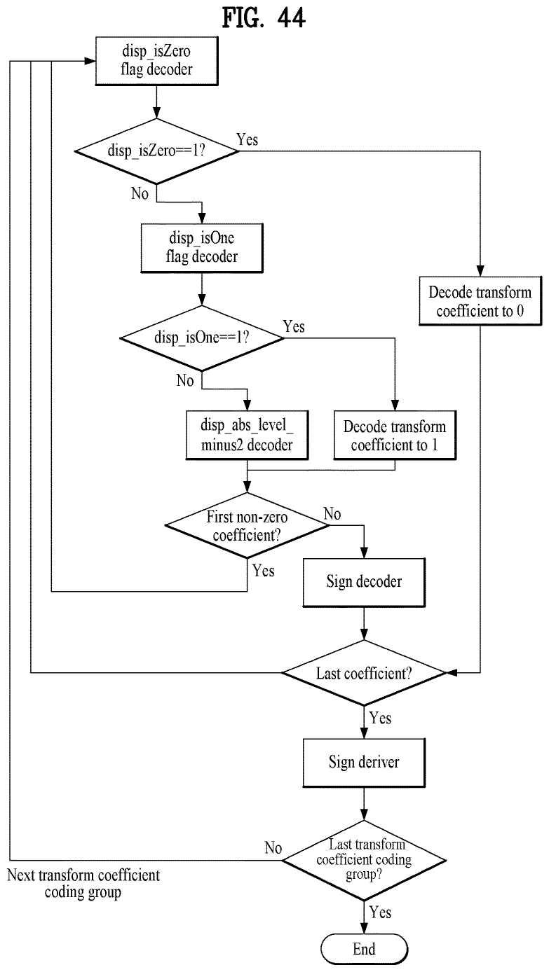

FIGS. 43 and 44 illustrate a method of decoding transform coefficients according to embodiments.

Quantized (residual) transform coefficients may be decoded by the quantized transform coefficient decoder as illustrated in FIG. 43.

A nonzero block flag (nonzero_block_flag) may be parsed. When the flag is equal to 0, all transform coefficients within the block may be decoded as 0.

When nonzero_block_flag is equal to 1, a nonzero subblock flag (nonzero_subblock_flag) may be additionally parsed.

When nonzero_subblock_flag is equal to 0, all transform coefficients within the subblock may be decoded as 0.

When nonzero_subblock_flag is equal to 1, the transform coefficients within the subblock may be decoded by the subblock decoder.

The block refers to a set of quantized displacement vector transform coefficients that is larger than a subblock, and nonzero_subblock_flag may be additionally decoded only for blocks with nonzero_block_flag equal to 1.

According to embodiments, the unit in which nonzero_block_flag is parsed may be the same as the subdivision level of the displacement vector.

A 1-bit flag may be encoded through nonzero_block_flag to signal whether a nonzero level value is present within the subdivision level.

nonzero_block_flag/nonzero_subblock_flag may have context information determined based on the type of the current mesh (inter-frame or intra-frame mesh) and/or subdivision level, and arithmetic decoding may be performed using arithmetic decoding based on different context information for each component of the displacement vector.

According to embodiments, decoding of nonzero_block_flag/nonzero_subblock_flag may be performed in the bypass mode using fixed probability values for arithmetic coding.

According to embodiments, a flag for a specific subdivision level (nonzero_block_flag and/or nonzero_subblock_flag) may be omitted and implicitly derived according to an agreement between the encoder and the decoder.

According to embodiments, the displacement vector transform coefficient decoder may operate separately for each dimension of the displacement vector (to parse block/subblock flags for each component). When the displacement vector is transformed into (n, t, b) to be decoded, the component n and the components t and b may be decoded.

In some embodiments, parsing of nonzero_block_flag and/or nonzero_subblock_flag may be skipped.

When nonzero_block_flag is omitted, nonzero_subblock_flag may be parsed, and the subblock decoder may decode subblocks with nonzero_subblock_flag equal to 1.

When nonzero_subblock_flag is omitted, transform coefficient decoding may be performed per transform coefficient coding group for blocks with nonzero_block_flag equal to 1.

When both nonzero_block_flag and nonzero_subblock_flag are omitted, transform coefficient decoding may be performed per transform coefficient coding group.

According to embodiments, the position of the first nonzero quantized transform coefficient (last_nonzero_pos) among the quantized transform coefficients may be decoded using exponential-Golomb coding based on separate context information.

After parsing last_nonzero_pos, transform coefficient values beyond the corresponding position may be implicitly derived as zero.

The subblock decoder according to embodiments is illustrated in FIG. 44.

According to embodiments, the isK (0, 1, . . . ) flag may be parsed to determine whether a transform coefficient equals K.

For subblocks with nonzero_subblock_flag equal to 1, transform coefficient decoding may be performed per transform coefficient coding group.

The transform coefficient coding group may be identical to or independent from a subblock.

According to embodiments, when the transform coefficient coding group is independent from the subblock, k non-zero transform coefficients may be grouped into one coding group according to the decoding order of displacement vectors.

According to embodiments, the size of the coding group may be variably determined by an agreement between the encoder and the decoder based on the subdivision level of the displacement vector, and/or QP value of the displacement vector, and/or mesh type (inter-frame or intra-frame mesh).

For the first non-zero transform coefficient decoded in the transform coefficient coding group, sign decoding may be skipped, and the sign may be derived by a sign deriver by checking the parity bit of the sum of the absolute values of the decoded transform coefficients in the coding group.

An embodiment of sign derivation performed when n non-zero transform coefficients are decoded in the transform coefficient coding group may be represented by the following equations.

$$sign ( {l}_{0} ) = parity ( abs ( {l}_{0} ) + abs ( {l}_{1} ) + … + abs ( {l}_{n - 1} ) ) ,$$

$$parity ( x ) = \{ \begin{matrix}+ , x : Even number \\ - , x : Odd number\end{matrix}$$

According to embodiments, the following parity function may be used:

$$parity ( x ) = \{ \begin{matrix}+ , x : Odd number \\ - , x : Even number\end{matrix}$$

According to embodiments, displacement vector transform coefficients may be decoded in descending order of indices of the vertices.

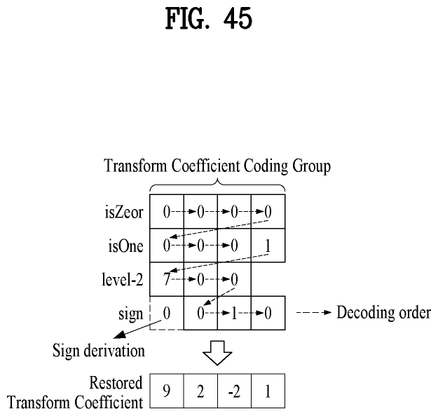

FIG. 45 illustrates a coding group of transform coefficients according to embodiments.

An embodiment of decoding a transform coefficient coding group when a subblock is decoded according the embodiment of FIG. 44 is illustrated in FIG. 45.

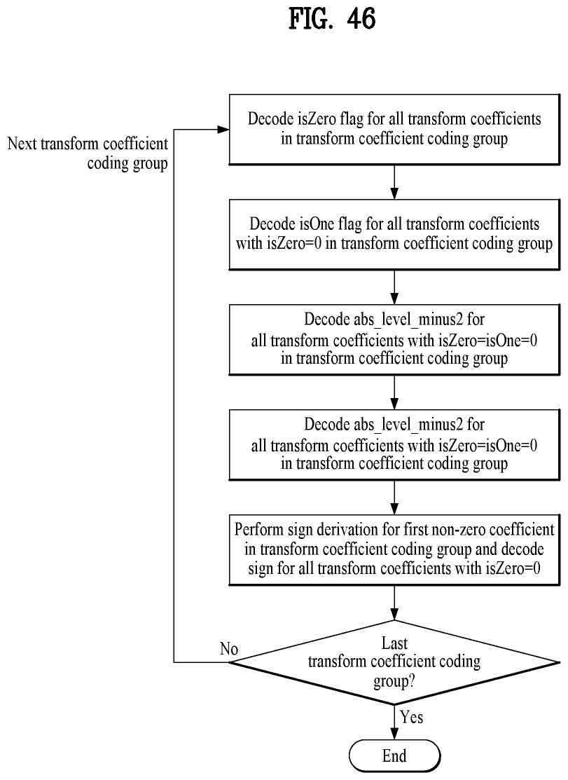

According to embodiments, transform coefficients for the subblock may be decoded as in the embodiment illustrated in FIG. 46.

Decoding of the sign for the first non-zero component in a coding group containing transform coefficients is omitted, and the coding group is decoded according to a specific order. Also, depending on whether the sum of absolute values within the coding group is even or odd, the sign for the first transform coefficient component may be derived. When the sum is even, the sign may be 0. Alternatively, depending on transmitter settings, the sign may be 1 when the sum is even.

FIGS. 46, 47, and 48 illustrate subblock-based decoding of transform coefficients according to embodiments.

According to embodiments, transform coefficients for the subblock may be decoded as in the embodiment illustrated in FIG. 46.

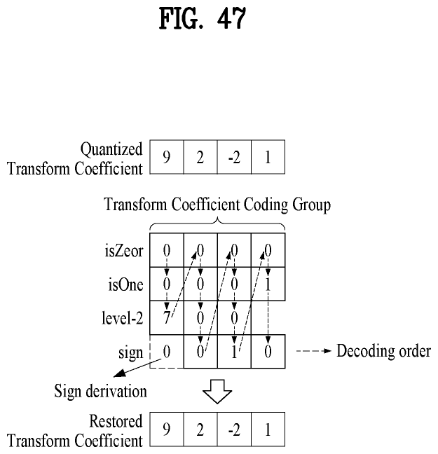

An embodiment of decoding a transform coefficient coding group when a subblock is decoded according the embodiment of FIG. 46 is illustrated in FIG. 47.

A coding group including quantized transform coefficients may be decoded in a specific order, and decoding of the sign of the first non-zero value may be skipped. The sign may be derived as 0 or 1 depending on the sum of the absolute values of the transform coefficients.

When k non-zero transform coefficients are grouped into one coding group according to the decoding order of displacement vectors, an embodiment of the subblock decoder is configured as follows.

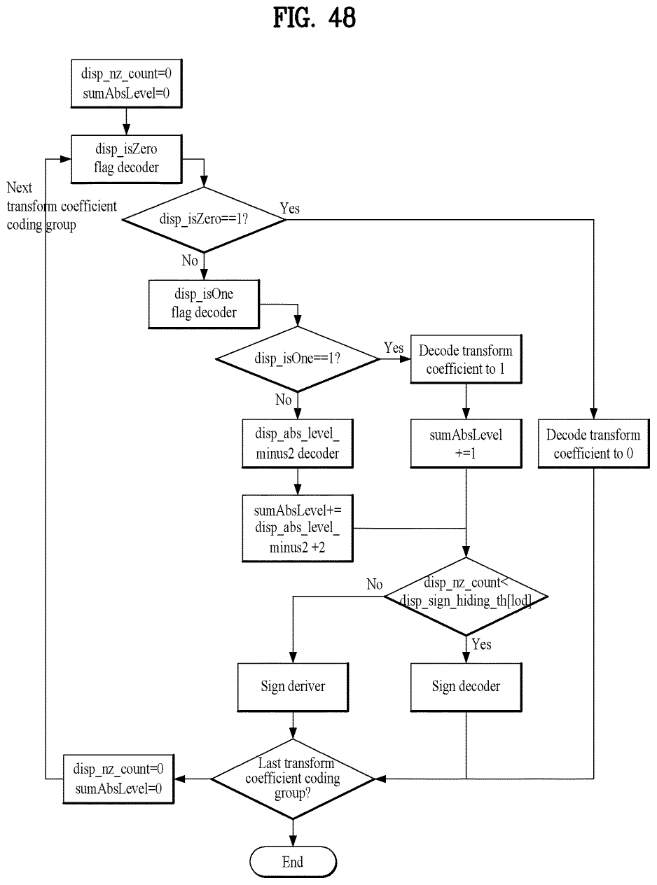

Referring to FIG. 48, the number of non-zero transform coefficients may be counted by disp_nz_count according to the decoding order of displacement vectors. Based on comparison between the counted value and disp_sign_hiding_th(=k), a threshold defined according to an agreement between the encoder and the decoder or parsed per frame, slice, or patch, sign derivation or sign decoding may be performed.

When disp_nz_count is less than disp_sign_hiding_th, sign decoding may be performed to decode the sign value (disp_sign_flag) of the current transform coefficient. When disp_nz_count is equal to disp_sign_hiding_th, the sign of the transform coefficient may be derived by the sign deriver based on sumAbsLevel.

In embodiments, the threshold of disp_sign_hiding_th may be determined based on the LoD level and/or QP.

The sign deriver may operate according to the following equation: disp_sign_flag-(sumAbsLevel % 2)? 0:1 or disp_sign_flag=(sumAbsLevel % 2)? 1:0

Inverse quantization is performed by the displacement vector transform coefficient inverse quantizer.

According to embodiments, quantization parameters (QP) for each axis may be transmitted per sequence or frame. When only the displacement vector of the normal component is encoded/decoded (onlyNormFlag=1), only the QP for the normal component may be parsed to determine the quantization rate.

According to embodiments, quantization may be performed on transform coefficients with different quantization parameters for each axis. The quantization or scaling parameters may be derived according to an agreement between the encoder and the decoder to determine the quantization rate for each LoD.

The displacement vector inverse transformer calculates the reconstructed displacement vector by performing the inverse transform on the inversely quantized displacement vector transform coefficients.

In embodiments, for the transformation, lifting transform or wavelet transform may be performed.

When lifting transform is performed, prediction is performed for vertex Rₖ at the k-th subdivision level, the displacement vector at the k-th subdivision level may be predicted using the subdivided vertex displacement vector of the predictor Rₜ (where t<k or t<=k).

According to embodiments, when performing displacement vector prediction, prediction may be performed based on an average or distance-based weighted average of the nearest n points among vertices at lower subdivision levels than the current vertex.

According to embodiments, prediction may be performed based on the displacement vectors of n vertices used to generate the current vertex during the mesh subdivision.

When lifting inverse transform is performed, displacement vectors of vertices used in the prediction by the encoder may be updated using the parsed residual signal.

According to embodiments, the transmission device (e.g., the transmission device 100 in FIG. 1, the mesh encoder 102 in FIG. 1, the pre-processor 200 and encoder 201 in FIGS. 2 and 3, the intra-frame encoding in FIG. 6, the inter-frame encoding in FIG. 7, the transmission device in FIG. 13, dynamic mesh encoding in FIGS. 15 to 29) may encode point cloud data, i.e., mesh data, generate signaling information (parameters) related to the encoding, and transmit a bitstream containing the data and the signaling information.

According to embodiments, the reception devices (e.g., the reception device 110 in FIG. 1, the mesh decoder 113 in FIG. 1, the intra-frame decoding in FIG. 11, the inter-frame decoding in FIG. 12, the reception device in FIG. 14, the dynamic mesh decoding in FIGS. 30 to 48) receive a bitstream, parse signaling information (parameters) included in the bitstream, and decode the encoded point cloud data, i.e., mesh data.

Hereinafter, related information contained in the bitstream is described with reference to FIGS. 49 to 51.

FIG. 49 shows information related to decoding of motion components contained in a bitstream according to embodiments.

FIG. 49 shows the syntax and semantics of decode motion for motion component decoding.
motion_nz_count (non-zero): Count value for the number of motion components
baseCount: Number of vertices in the base mesh
sumAbsMotion: Sum of absolute values of restored motion components in a motion component coding group for sign bit hiding
motion_isZero[d][v]: Flag indicating whether the motion component is 0
motion_isOne[d][v]: Flag indicating whether the motion component is 1
motion_abs_minus2[d][v]: Absolute value of the motion component minus 2
motion_sign_flag[d][v]: Flag indicating the sign value of the motion component: 0 indicates positive (+), 1 indicates negative (−)
mv_sign_hiding_th: Threshold to determine the number of non-zero motion components to be grouped into one coding group (CG)
mv[d][v]: Restored motion components

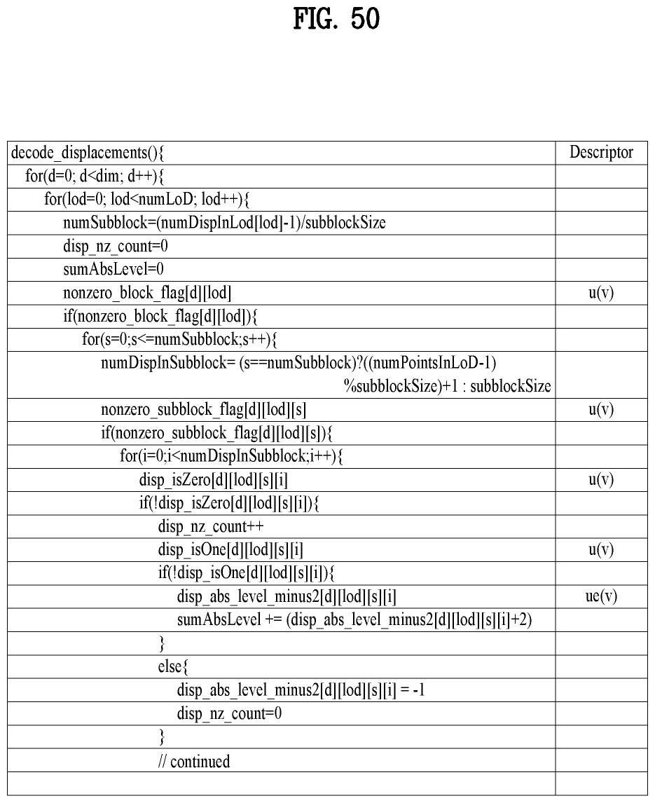

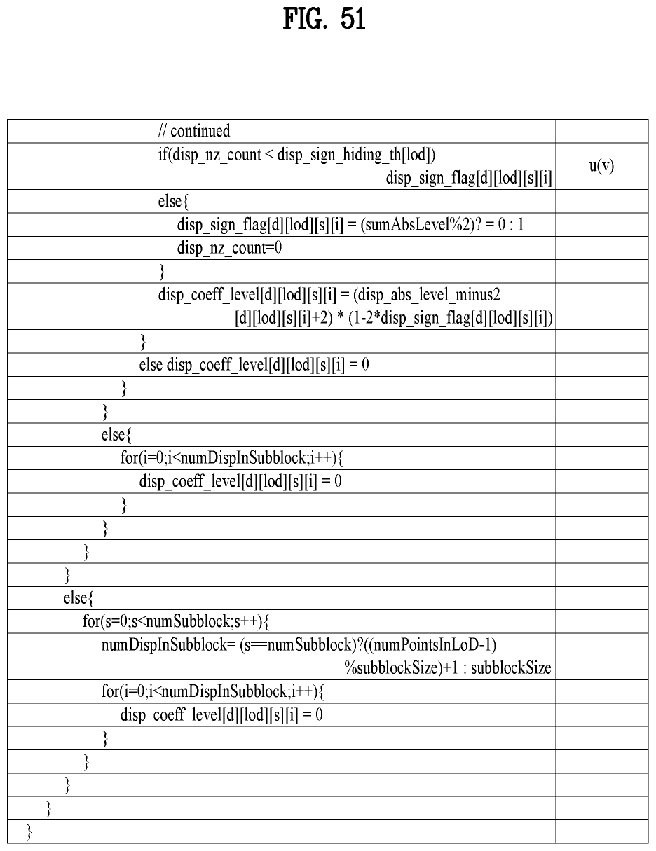

FIGS. 50 and 51 show information related to decoding of transform coefficients of displacement vectors contained in a bitstream according to embodiments.
numDispInLoD[lod]: Number of displacement vectors in the current LoD
numSubblock: Number of subblocks in the current LoD (block)
disp_nz_count: Count value for the number of non-zero transform coefficients
nonzero_block_flag[d][lod]: Flag indicating whether non-zero transform coefficients are present in the current block
numDispInSubblock: Number of transform coefficients in the current subblock
nonzero_subblock_flag[d][lod][s]: Flag indicating whether non-zero transform coefficients are present in the current subblock
disp_isZero[d][lod][s][i]: Flag indicating whether the transform coefficient is 0
disp_isOne[d][lod][s][i]: Flag indicating whether the transform coefficient is 1
disp_abs_level_minus2[d][lod][s][i]: Absolute value of the transform coefficient minus 2
disp_sign_flag [d][lod][s][i]: Flag indicating the sign value of the transform coefficient: 0 indicates positive (+), 1 indicates negative (−)
disp_coeff_level [d][lod][s][i]: Restored transform coefficient level

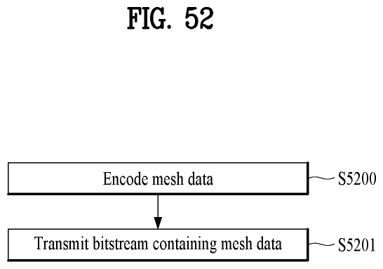

FIG. 52 illustrates a method of transmitting mesh data according to embodiments.

FIG. 52 illustrates a method of transmitting mesh data (point cloud data) by a transmission device according to embodiments (which includes or performs the transmission device 100 in FIG. 1, the mesh encoder 102 in FIG. 1, the pre-processor 200 and encoder 201 in FIGS. 2 and 3, the mesh subdivision in FIG. 4 and the mesh displacement calculation in FIG. 5, the intra-frame encoding in FIG. 6, the inter-frame encoding in FIG. 7, the lifting transform of displacement in FIG. 8, the packing of transform coefficients in FIG. 9, the attribute transfer in FIG. 10, the transmission device in FIG. 13, the dynamic mesh encoding in FIGS. 15 to 29, and the generation of a bitstream containing signaling information (parameters) in FIGS. 49 to 51).

In S5200, the mesh data transmission method according to the embodiments may include encoding mesh data.

In S5201, the mesh data transmission method according to the embodiments may further include transmitting a bitstream containing the mesh data.

Referring to FIG. 15, regarding the dynamic mesh encoder, the encoding mesh data (S5200) may include performing decimation by generating base mesh data from the mesh data, performing parameterization by generating at least one of texture coordinates or connectivity information related to vertices of the base mesh data, quantizing at least one of geometry information, the texture coordinates, or normal information related to the base mesh data, or encoding a motion vector generated based on the base mesh data and a reference base mesh data for the base mesh data.

Referring to FIG. 16, regarding motion vector encoding per coding group of motion components, the encoding of the motion vector may include determining whether to adjust a value of a motion component of the motion vector, adjusting the value of the motion component based on the determination, and performing arithmetic coding on the value of the motion component.

Referring to FIGS. 16, 17, and 18, regarding encoding per coding group of motion components, the encoding of the motion vector may be performed based on a coding group of motion components of the motion vector including a zero motion component. The determining of whether to adjust the value of the motion component may include determining whether a sign value according to whether a sum of absolute values of the motion components including the zero motion component in the coding group is an even number or an odd number matches an encoded value of a first non-zero motion component in the coding group. Based on that the sign value related to the sum of the absolute values does not match the encoded value of the first non-zero motion component in the coding group, the adjusting of the value of the motion component may include adjusting at least one of the values of the motion components in the coding group. The arithmetic coding may include encoding the values in the coding group based on a specific order.

Referring to FIGS. 17 and 18, regarding definition of the coding group and omission of the first sign value, the coding group may include a value indicating whether each of values obtained by quantizing the values of the motion components is equal to zero, a value indicating whether each of the quantized values is equal to 1, a value indicating a value of a level minus 2, and a value indicating the sign value. A value indicating the sign value of the first non-zero motion component in the coding group is omitted in the encoding.

Referring to FIGS. 15, 20, 21, 22, 23, 24, and 25, regarding displacement vectors in dynamic mesh encoding, the encoding of the mesh data may include subdividing the base mesh data, adjusting positions of vertices of the subdivided base mesh data, generating a displacement vector based on the adjusted base mesh data and reconstructed base mesh data, transforming a coordinate system of the displacement vector, and encoding the displacement vector. The encoding of the displacement vector may include quantizing, packing, and encoding transform coefficients of the displacement vector, or include predicting the transform coefficients of the displacement vector based on transform coefficients of a reference frame and encoding transform coefficients including a residual, the residual being generated based on the predicted transform coefficients.

Referring to FIGS. 27 and 28, regarding subblock encoding, the encoding of the transform coefficients may include skipping encoding of a sign of a first non-zero value in a coding group of the transform coefficients, determining whether a sign value according to whether a sum of absolute values of values in the coding group of the transform coefficients is an even number or an odd number matches a value of the sign of the first non-zero value in the coding group, and, based on that the sum of the absolute values does not match the value of the sign, adjusting each of the values in the coding group and performing arithmetic coding on the adjusted values.

The method in FIG. 52 may be performed by the transmission device (mesh data transmission device) of FIG. 1. The mesh data transmission device may include a memory and a processor configured to execute one or more instructions in the memory. The processor may be configured to encode mesh data and transmit a bitstream containing the mesh data.

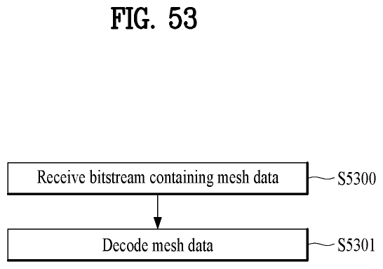

FIG. 53 illustrates a method of receiving mesh data according to embodiments.

The reception device according to the embodiments is the reception advice 110 in FIG. 1, and the decoder according to the embodiments includes the mesh decoder 113 in FIG. 1, the intra-frame decoding in FIG. 11, the inter-frame decoding in FIG. 12, the the reception device in FIG. 14, the dynamic mesh decoding in FIGS. 30 to 48, and the reception of a bitstream containing signaling information (parameters) in FIGS. 49 to 51.

In S5300, the mesh data reception method according to the embodiments may include receiving a bitstream containing mesh data.

In S5301, the mesh data reception method according to the embodiments may further include decoding the mesh data.

Referring to FIG. 30, regarding motion vector decoding in dynamic mesh decoding, the decoding of the mesh data (S5301) may include decoding a motion vector contained in the bitstream. The decoding of the motion vector may include skipping decoding of a sign of a first non-zero value in a coding group of the motion vector, and deriving the sign of the first non-zero value in the coding group based on whether a sign value according to whether a sum of absolute values of values in the coding group is an even number or an odd number matches a value of the sign of the first non-zero value in the coding group.

Referring to FIGS. 30, 39, and 40, regarding the decoding of the transform coefficients of displacement vectors, the decoding of the mesh data may include decoding a displacement vector contained in the bitstream.

The decoding of the displacement vector may include decoding a video of transform coefficients of the displacement vector, and unpacking, inversely quantizing, and inversely transforming an image of the transform coefficients, or include decoding the transform coefficients of the displacement vector and performing prediction based on transform coefficients in a reference frame.

Referring to FIGS. 43 and 44, regarding transform coefficient decoding, the decoding of the transform coefficients of the displacement vector may include skipping decoding of a sign of a first non-zero value in a coding group of the transform coefficients, and deriving the sign of the first non-zero value in the coding group based on whether a sign value according to whether a sum of absolute values of values in the coding group is an even number or an odd number matches a sign value of the first non-zero value in the coding group.

Referring to FIG. 49, regarding syntax of signaling information contained in the bitstream, the bitstream may contain at least one of a count value related to a number of motion components, a number of vertices in a base mesh, a sum of absolute values of motion components in a coding group, a flag indicating whether the motion components are equal to 0, a flag indicating whether the motion components are equal to 1, a value obtained by subtracting 2 from each of the absolute values of the motion components, a flag indicating a sign of each of the motion components, a threshold for a number of non-zero motion components in the coding group, or the motion components.

Referring to FIGS. 50 and 51, the bitstream may contain at least one of a value indicating a number of displacement vectors in a level of detail, a value indicating a number of subblocks in the level of detail, a count value related to a number of transform coefficients, a flag indicating whether a non-zero transform coefficient is present in a block, a value indicating a number of transform coefficients in the subblocks, a value indicating whether a non-zero transform coefficient is present in the subblocks, a flag indicating whether the transform components are equal to 0, a flag indicating whether the transform components are equal to 1, a value obtained by subtracting 2 from each of absolute values of the transform coefficients, a flag indicating a sign of the transform coefficients, or a level of the transform coefficients.

The method in FIG. 53 may be performed by the reception device in FIG. 1. The mesh data reception device may include a memory and a processor configured to execute one or more instructions in the memory. The processor may be configured to receive a bitstream containing mesh data and decode the mesh data.

Embodiments relate to a method of encoding a displacement vector and a motion vector, which are components encoded in V-DMC. When these two components are encoded using arithmetic coding, the proposed method may improve compression performance. By applying an arithmetic coding method utilizing block-based context information, the number of sign bits encoded may be reduced compared to conventional methods, and the decoder may be allowed to derive the omitted sign bits. Thereby, fewer encoded bits may be generated than in basic methods. Thus, the compression performance of dynamic mesh data in V-DMC may be improved, thereby enhancing the usability of V-DMC technology and reducing resource usage costs in execution environments.

The embodiments have been described in terms of a method and/or a device. The description of the method and the description of the device may complement each other.

Although embodiments have been described with reference to each of the accompanying drawings for simplicity, it is possible to design new embodiments by merging the embodiments illustrated in the accompanying drawings. If a recording medium readable by a computer, in which programs for executing the embodiments mentioned in the foregoing description are recorded, is designed by those skilled in the art, it may also fall within the scope of the appended claims and their equivalents. The devices and methods may not be limited by the configurations and methods of the embodiments described above. The embodiments described above may be configured by being selectively combined with one another entirely or in part to enable various modifications. Although preferred embodiments have been described with reference to the drawings, those skilled in the art will appreciate that various modifications and variations may be made in the embodiments without departing from the spirit or scope of the disclosure described in the appended claims. Such modifications are not to be understood individually from the technical idea or perspective of the embodiments.

Various elements of the devices of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the device according to the embodiments may include one or more processors capable of executing one or more programs. The one or more programs may perform any one or more of the operations/methods according to the embodiments or include instructions for performing the same. Executable instructions for performing the method/operations of the device according to the embodiments may be stored in a non-transitory CRM or other computer program products configured to be executed by one or more processors, or may be stored in a transitory CRM or other computer program products configured to be executed by one or more processors. In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion.

In this document, the term “/” and “,” should be interpreted as indicating “and/or.” For instance, the expression “A/B” may mean “A and/or B.” Further, “A, B” may mean “A and/or B.” Further, “A/B/C” may mean “at least one of A, B, and/or C.” “A, B, C” may also mean “at least one of A, B, and/or C.” Further, in the document, the term “or” should be interpreted as “and/or.” For instance, the expression “A or B” may mean 1) only A, 2) only B, and/or 3) both A and B. In other words, the term “or” in this document should be interpreted as “additionally or alternatively.”

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signal unless context clearly dictates otherwise.

The terminology used to describe the embodiments is used for the purpose of describing particular embodiments only and is not intended to be limiting of the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components. As used herein, conditional expressions such as “if” and “when” are not limited to an optional case and are intended to be interpreted, when a specific condition is satisfied, to perform the related operation or interpret the related definition according to the specific condition.

Operations according to the embodiments described in this specification may be performed by a transmission/reception device including a memory and/or a processor according to embodiments. The memory may store programs for processing/controlling the operations according to the embodiments, and the processor may control various operations described in this specification. The processor may be referred to as a controller or the like. In embodiments, operations may be performed by firmware, software, and/or combinations thereof. The firmware, software, and/or combinations thereof may be stored in the processor or the memory.

The operations according to the above-described embodiments may be performed by the transmission device and/or the reception device according to the embodiments. The transmission/reception device may include a transmitter/receiver configured to transmit and receive media data, a memory configured to store instructions (program code, algorithms, flowcharts and/or data) for the processes according to the embodiments, and a processor configured to control the operations of the transmission/reception device.

The processor may be referred to as a controller or the like, and may correspond to, for example, hardware, software, and/or a combination thereof. The operations according to the above-described embodiments may be performed by the processor. In addition, the processor may be implemented as an encoder/decoder for the operations of the above-described embodiments.

### MODE FOR DISCLOSURE

Various embodiments have been described in the best mode for carrying out the disclosure.

### INDUSTRIAL APPLICABILITY

As described above, the embodiments may be fully or partially applied to the point cloud data transmission/reception device and system.

It will be apparent to those skilled in the art that various changes or modifications may be made to the embodiments within the scope of the embodiments.

Thus, it is intended that the embodiments cover modifications/variations provided they come within the scope of the appended claims and their equivalents.

1. A method of transmitting mesh data, the method comprising:
encoding mesh data; and
transmitting a bitstream containing the mesh data.

2. The method of claim 1, wherein the encoding of the mesh data comprises:
performing decimation by generating base mesh data from the mesh data;
performing parameterization by generating at least one of texture coordinates or connectivity information related to vertices of the base mesh data;
quantizing at least one of geometry information, the texture coordinates, or normal information related to the base mesh data; or
encoding a motion vector generated based on the base mesh data and a reference base mesh data for the base mesh data.

3. The method of claim 2, wherein the encoding of the motion vector comprises:
determining whether to adjust a value of a motion component of the motion vector;
adjusting the value of the motion component based on the determination; and
performing arithmetic coding on the value of the motion component.

4. The method of claim 3, wherein the encoding of the motion vector is performed based on a coding group of motion components of the motion vector including a zero motion component,
wherein the determining of whether to adjust the value of the motion component comprises:
determining whether a sign value according to whether a sum of absolute values of the motion components including the zero motion component in the coding group is an even number or an odd number matches an encoded value of a first non-zero motion component in the coding group,
wherein, based on that the sign value related to the sum of the absolute values does not match the encoded value of the first non-zero motion component in the coding group, the adjusting of the value of the motion component comprises:
adjusting at least one of the values of the motion components in the coding group,
wherein the arithmetic coding comprises:
encoding the values in the coding group based on a specific order.

5. The method of claim 4, wherein the coding group comprises:
a value indicating whether each of values obtained by quantizing the values of the motion components is equal to zero;
a value indicating whether each of the quantized values is equal to 1;
a value indicating a value of a level minus 2; and
a value indicating the sign value,
wherein a value indicating the sign value of the first non-zero motion component in the coding group is omitted in the encoding.

6. The method of claim 2, wherein the encoding of the mesh data comprises:
subdividing the base mesh data;
adjusting positions of vertices of the subdivided base mesh data;
generating a displacement vector based on the adjusted base mesh data and reconstructed base mesh data;
transforming a coordinate system of the displacement vector; and
encoding the displacement vector,
wherein the encoding of the displacement vector comprises:
quantizing, packing, and encoding transform coefficients of the displacement vector; or
predicting the transform coefficients of the displacement vector based on transform coefficients of a reference frame and encoding transform coefficients including a residual, the residual being generated based on the predicted transform coefficients.

7. The method of claim 6, wherein the encoding of the transform coefficients comprises:
skipping encoding of a sign of a first non-zero value in a coding group of the transform coefficients;
determining whether a sign value according to whether a sum of absolute values of values in the coding group of the transform coefficients is an even number or an odd number matches a value of the sign of the first non-zero value in the coding group; and
based on that the sum of the absolute values does not match the value of the sign, adjusting each of the values in the coding group and performing arithmetic coding on the adjusted values.

8. A device for transmitting mesh data, comprising:
a memory; and
a processor configured to execute one or more instructions in the memory,
wherein the processor is configured to:
encode mesh data; and
transmit a bitstream containing the mesh data.

9. A method of receiving mesh data, the method comprising:
receiving a bitstream containing mesh data; and
decoding the mesh data.

10. The method of claim 9, wherein the decoding of the mesh data comprises:
decoding a motion vector contained in the bitstream,
wherein the decoding of the motion vector comprises:
skipping decoding of a sign of a first non-zero value in a coding group of the motion vector; and
deriving the sign of the first non-zero value in the coding group based on whether a sign value according to whether a sum of absolute values of values in the coding group is an even number or an odd number matches a value of the sign of the first non-zero value in the coding group.

11. The method of claim 9, wherein the decoding of the the mesh data comprises:
decoding a displacement vector contained in the bitstream,
wherein the decoding of the displacement vector comprises:
decoding a video of transform coefficients of the displacement vector, and unpacking, inversely quantizing, and inversely transforming an image of the transform coefficients; or
decoding the transform coefficients of the displacement vector and performing prediction based on transform coefficients in a reference frame.

12. The method of claim 11, wherein the decoding of the transform coefficients of the displacement vector comprises:
skipping decoding of a sign of a first non-zero value in a coding group of the transform coefficients; and
deriving the sign of the first non-zero value in the coding group based on whether a sign value according to whether a sum of absolute values of values in the coding group is an even number or an odd number matches a sign value of the first non-zero value in the coding group.

13. The method of claim 9, wherein the bitstream contains at least one of:
a count value related to a number of motion components;
a number of vertices in a base mesh;
a sum of absolute values of motion components in a coding group;
a flag indicating whether the motion components are equal to 0;
a flag indicating whether the motion components are equal to 1;
a value obtained by subtracting 2 from each of the absolute values of the motion components;
a flag indicating a sign of each of the motion components;
a threshold for a number of non-zero motion components in the coding group; or
the motion components.

14. The method of claim 9, wherein the bitstream contains at least one of:
a value indicating a number of displacement vectors in a level of detail;
a value indicating a number of subblocks in the level of detail;
a count value related to a number of transform coefficients;
a flag indicating whether a non-zero transform coefficient is present in a block;
a value indicating a number of transform coefficients in the subblocks;
a value indicating whether a non-zero transform coefficient is present in the subblocks;
a flag indicating whether the transform components are equal to 0;
a flag indicating whether the transform components are equal to 1;
a value obtained by subtracting 2 from each of absolute values of the transform coefficients;
a flag indicating a sign of the transform coefficients; or
a level of the transform coefficients.

15. (canceled)
